(19) United States
(12) Patent Application Publication
(10) Pub. No.: US 2025/0230091 A1
(43) Pub. Date: Jul. 17, 2025

(54) WINDOW GLASS MANUFACTURING DEVICE AND WINDOW GLASS MANUFACTURING METHOD USING THE DEVICE

(71) Applicant: Samsung Display Co., LTD., Yongin-si (KR)

(72) Inventors: SEUNGPYO HONG, Yongin-si (KR); DONGHO KIM, Yongin-si (KR); BYOUNGYUL SHIM, Yongin-si (KR); JUSUK OH, Yongin-si (KR)

(21) Appl. No.: 19/018,437

(22) Filed: Jan. 13, 2025

(30) Foreign Application Priority Data
Jan. 15, 2024 (KR) 10-2024-0006147
Sep. 5, 2024 (KR) 10-2024-0120480

(51) Int. Cl. C03C 15/00; C03B 23/023

(52) U.S. Cl. CPC C03C 15/00; C03B 23/023

(57) ABSTRACT

A window glass manufacturing device includes a base jig including a groove area concavely recessed with respect to flat surfaces and a nozzle portion disposed above the base jig so as to correspond to the groove area and controlled to move in at least one of the upward/downward direction or the left/right direction which is parallel to the first direction, thereby having excellent surface quality.

This application claims priority to Korean Patent Application No. 10-2024-0006147, filed on Jan. 15, 2024, and Korean Patent Application No. 10-2024-0120480, filed on Sep. 5, 2024, the entirety of the contents of which are hereby incorporated by reference.

### BACKGROUND

### 1. Field

The disclosure herein relates to a window glass manufacturing device and a window glass manufacturing method, and more particularly, to a window glass manufacturing device for manufacturing window glass including a partially slimmed region, and a window glass manufacturing method using the device.

### 2. Description of the Related Art

Various types of electronic devices are being used to provide image information, and recently, electronic devices including a flexible display panel capable of being folded or bent are under development. Unlike rigid electronic devices, flexible electronic devices have the characteristic of being portable without being limited by the size of the screen on which images are displayed, as their shapes may be altered in various ways, such as folding, rolling, or bending. A window is desired in such flexible electronic devices to protect a display panel without hindering folding or bending operation. Accordingly, it is desired to develop a manufacturing method and a manufacturing device for a window having excellent surface characteristics that have good folding characteristics and do not affect display quality.

### SUMMARY

The disclosure provides a manufacturing method and a manufacturing device for window glass having excellent surface properties.

The disclosure also provides a window glass manufacturing method and a window glass manufacturing device, which have excellent processability and are capable of easily controlling the shape of a slimming region of a window.

An embodiment of the inventive concept provides a window glass manufacturing device including a base jig including flat surfaces spaced apart from each other in a first direction and a groove area concavely recessed with respect to the flat surfaces and extending in a second direction and a nozzle portion disposed above the base jig so as to correspond to the groove area and controlled to move in at least one of a first moving direction or a second moving direction which is parallel to the first direction and perpendicular to the first moving direction.

In an embodiment, an upper surface of the groove area may include a curved surface without a discontinuity or an inclined surface without a discontinuity.

In an embodiment, the nozzle portion may move along a shape of an upper surface of the groove area within a region corresponding to the groove area.

In an embodiment, an inclination angle of the inclined surface may be between 10 or more degrees and about 45 or less degrees.

In an embodiment, the nozzle portion may include a first nozzle portion and a second nozzle portion spaced apart from each other in the first direction with respect to a center of the base jig.

In an embodiment, the first nozzle portion and the second nozzle portion may follow a shape of an upper surface of the groove area and be controlled to move in opposite directions with respect to the center.

In an embodiment, each of the first nozzle portion and the second nozzle portion may be controlled to move while maintaining a predetermined distance from the upper surface of the groove area.

In an embodiment, the nozzle portion may include a plurality of sub-nozzle portions arranged in the first direction, and open and closed states of the sub-nozzle portions or discharge amounts discharged from the sub-nozzle portions may be independently controlled.

In an embodiment, vacuum suction inlets may be defined in the groove area of the base jig.

In an embodiment, the base jig may include a plurality of sub-jigs separated from each other, and a shape of the groove area may be adjusted by a combination of the plurality of sub-jigs.

In an embodiment of the inventive concept, a window glass manufacturing method, which uses a window glass manufacturing device including a base jig including a concavely recessed groove area and a nozzle portion disposed above the base jig and controlled to move in a region corresponding to the groove area, includes: bending a base glass so as to include a bending portion inserted into the groove area; fixing the base glass to the base jig so that the bending portion is disposed along a shape of an upper surface of the groove area; and providing an etching solution onto the upper surface of the base glass disposed in the groove area using the nozzle portion.

In an embodiment, the providing the etching solution may include controlling a degree of etching by the etching solution according to the position on the upper surface of the base glass to form a window having a recessed area defined therein and including a curved surface without a discontinuity or an inclined surface without a discontinuity on the upper surface of the base glass.

In an embodiment, the providing the etching solution may include controlling at least one of an exposure time to the etching solution or an amount of the etching solution provided, depending on a position on the upper surface of the base glass.

In an embodiment, the fixing the base glass to the base jig may be fixing one surface of the base glass by suction through a vacuum suction inlet defined in the groove area.

In an embodiment, the nozzle portion may include a first nozzle portion and a second nozzle portion spaced apart from each other in a first direction, and the providing the etching solution may include continuously providing the etching solution onto the upper surface of the base glass while moving each of the first nozzle portion and the second nozzle portion from a center of the groove area toward an outer direction.

In an embodiment, each of the first nozzle portion and the second nozzle portion may be controlled to move so as to follow the shape of the upper surface of the groove area while maintaining a predetermined distance from the upper surface of the base glass.

In an embodiment, the nozzle portion may include a first nozzle portion and a second nozzle portion fixedly spaced apart from each other in opposite directions at a predetermined distance with respect to a center of the base jig, and in the providing the etching solution, the etching solution discharged from each of the first nozzle portion and the second nozzle portion may be provided to flow along the upper surface of the base glass in a direction of the center at a portion corresponding to a position of each of the first nozzle portion and the second nozzle portion.

In an embodiment, the nozzle portion may include a plurality of sub-nozzle portions arranged in a first direction so as to correspond to the groove area, and the providing the etching solution may be providing the etching solution by sequentially controlling the sub-nozzle portions to open, starting from a center of the groove area and progressing toward an outer portion of the groove area.

In an embodiment, the nozzle portion may include a plurality of sub-nozzle portions arranged in a first direction so as to correspond to the groove area, and the providing the etching solution may include controlling the sub-nozzle portions so that an amount of the etching solution provided from the sub-nozzle portions disposed in a central portion of the groove area is greater than an amount of the etching solution provided from the sub-nozzle portions disposed in the outer portions of the groove area.

In an embodiment, the window glass manufacturing device may further include a guide portion disposed to be spaced apart from one side of the nozzle portion above the base jig, and the providing the etching solution may include controlling the movement of the guide portion and the nozzle portion to follow the shape of the upper surface of the groove area while maintaining a predetermined separation distance therebetween.

### BRIEF DESCRIPTION OF THE DRAWINGS

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1A is a perspective view illustrating an embodiment of an unfolded state of an electronic device according to the inventive concept;

FIG. 1B is a perspective view illustrating an embodiment of an in-folding process of the electronic device in an embodiment of the inventive concept illustrated in FIG. 1A;

FIG. 1C is a perspective view illustrating an embodiment of an out-folding process of the electronic device in an embodiment of the inventive concept illustrated in FIG. 1A;

FIG. 2A is a perspective view illustrating an embodiment of an unfolded state of an electronic device according to the inventive concept;

FIG. 2B is a perspective view illustrating an embodiment of an in-folding process of the electronic device according to the inventive concept illustrated in FIG. 2A;

FIG. 2C is a perspective view illustrating an embodiment of an out-folding process of the electronic device according to the inventive concept illustrated in FIG. 2A;

FIG. 3A is a perspective view of an embodiment of an electronic device according to the inventive concept;

Each of FIGS. 3B and 3C is a perspective view illustrating a multi-folded state of the electronic device illustrated in FIG. 3A;

FIG. 4 is an exploded perspective view of an embodiment of an electronic device according to the inventive concept;

FIG. 5 is a cross-sectional view of an embodiment of the electronic device according to the inventive concept;

Each of FIGS. 6A and 6B is a cross-sectional view of an embodiment of window glass according to the inventive concept;

FIG. 7 is a perspective view of an embodiment of a window glass manufacturing device according to the inventive concept;

Each of FIGS. 8A to 8C illustrates an embodiment of a base jig according to the inventive concept;

Each of FIGS. 9A and 9B is a cross-sectional view of an embodiment of a window glass manufacturing device according to the inventive concept;

Each of FIGS. 10A and 10B is a cross-sectional view of an embodiment of a window glass manufacturing device according to the inventive concept;

FIG. 11 is a cross-sectional view of an embodiment of a window glass manufacturing device according to the inventive concept;

FIG. 12 is a flow chart of an embodiment of a window glass manufacturing method according to the inventive concept;

Each of FIGS. 13A to 13E illustrates an embodiment of one operation of the window glass manufacturing method according to the inventive concept;

Each of FIGS. 14A and 14B illustrates an embodiment of one operation of the window glass manufacturing method according to the inventive concept;

FIG. 14C is an enlarged view of a portion of FIG. 14A;

Each of FIGS. 15A and 15B illustrates an embodiment of one operation of the window glass manufacturing method according to the inventive concept;

FIG. 16 illustrates an embodiment of one operation of the window glass manufacturing method according to the inventive concept;

FIG. 17A is a partial perspective view illustrating an embodiment of one operation of the window glass manufacturing method according to the inventive concept; and

FIG. 17B is a cross-sectional view illustrating an embodiment of one operation of the window glass manufacturing method according to the inventive concept.

### DETAILED DESCRIPTION

In the invention, various modifications may be made, various forms may be used, and illustrative embodiments will be illustrated in the drawings and described in detail in the text. However, this is not intended to limit the invention to a predetermined form disclosed, and it will be understood that all changes, equivalents, or substitutes which fall in the spirit and technical scope of the invention should be included.

In this specification, it will be understood that when an element (or region, layer, portion, etc.) is referred to as being “on”, “connected to” or “coupled to” another element, it may be directly on, connected or coupled to the other element, or intervening elements may be present.

Like reference numerals refer to like elements throughout. In addition, in the drawings, the thicknesses, ratios, and dimensions of elements are exaggerated for effective description of the technical contents. As used herein, the term “and/or” includes any and all combinations that the associated configurations may define.

It will be understood that, although the terms first, second, etc. may be used herein to describe various elements, these elements should not be limited by these terms. These terms are only used to distinguish one element from another element. For example, a first element could be termed a second element without departing from the scope of the invention. Similarly, the second element may also be referred to as the first element. The terms of a singular form include plural forms unless otherwise specified.

In addition, terms, such as “below”, “lower”, “above”, “upper” and the like, are used herein for ease of description to describe one element's relation to another element(s) as illustrated in the drawing figures. The above terms are relative concepts and are described based on the directions indicated in the drawings.

It will be understood that the terms “include” and/or “have”, when used in this specification, specify the presence of stated features, integers, steps, operations, elements, components and/or groups thereof, but do not preclude the presence or addition of one or more other features, integers, steps, operations, elements, components, and/or groups thereof.

In this specification, the expression “being directly disposed” may mean that there is no layer, film, region, plate, or the like which is added between a part of a layer, film, region, plate, or the like and another part. For example, the expression “being directly disposed” may mean being disposed between two layers or two members without an additional member such as an adhesive member interposed therebetween.

In this specification, the expression “a region/portion corresponds to another region/portion” means that “they overlap each other”, but the expression is not limited to having a same area and/or a same shape. In addition, in this specification, the expression “a region/portion overlaps another region/portion” includes a case in which the regions/portions indicated as overlapping each other when viewed in a plan view at least partially overlap each other in a plan view.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). The term “about” can mean within one or more standard deviations, or within +30%, 20%, 10%, 5% of the stated value, for example.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, an electronic device in an embodiment of the inventive concept, a window glass manufacturing device in an embodiment of the inventive concept, and a window glass manufacturing method in an embodiment of the inventive concept will be described with reference to the drawings.

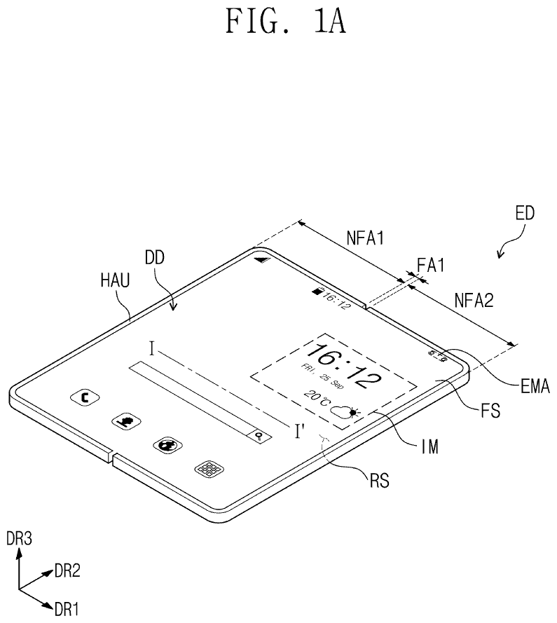

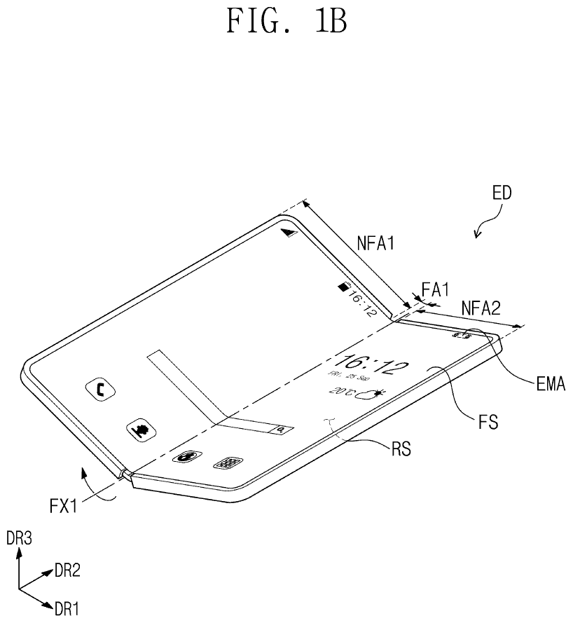

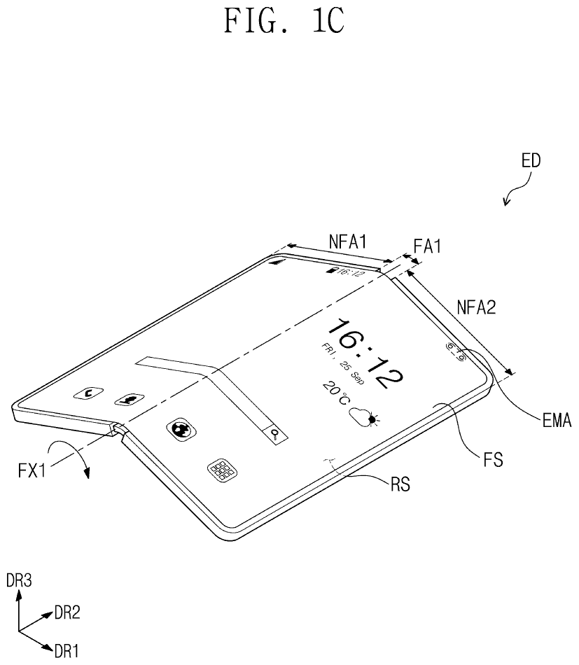

FIGS. 1A to 5 illustrate an electronic device in an embodiment of the inventive concept, and the electronic device in an embodiment of the inventive concept illustrated in FIGS. 1A to 5 includes a window manufactured by a window manufacturing device in an embodiment of the inventive concept and a window glass manufacturing method in an embodiment of the inventive concept, which will be described later.

FIG. 1A is a perspective view illustrating an embodiment of an unfolded state of an electronic device according to the inventive concept. FIG. 1B is a perspective view illustrating an in-folding process of the electronic device illustrated in FIG. 1A. FIG. 1C is a perspective view illustrating an out-folding process of the electronic device illustrated in FIG. 1A.

The electronic device ED in an embodiment of the inventive concept may be activated according to an electrical signal. In an embodiment, the electronic device ED may be a mobile phone, a tablet, a car navigation system, a game console, or a wearable device, for example, but the inventive concept is not limited thereto. In this specification, FIG. 1A illustrates the electronic device ED as a mobile phone.

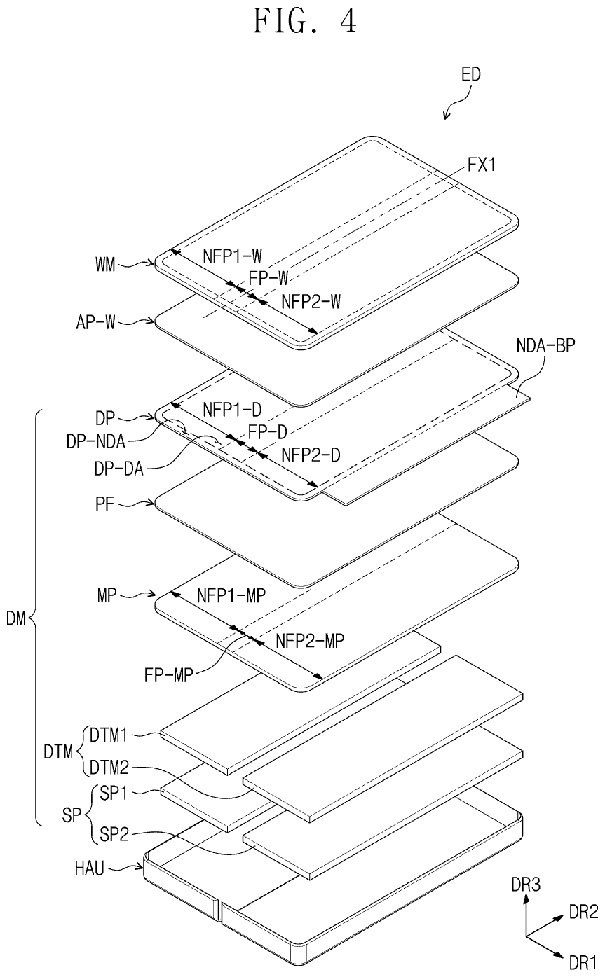

Referring to FIGS. 1A to 1C, the electronic device ED in an embodiment of the inventive concept may include a first display surface FS defined by a first directional axis DR1 and a second directional axis DR2 crossing the first directional axis DR1. The electronic device ED may provide an image IM to a user through the first display surface FS. That is, the electronic device ED may include a display device DD including a display module DM (refer to FIG. 4). The electronic device ED in an embodiment of the inventive concept may display an image IM toward a third directional axis DR3 through the first display surface FS parallel to each of the first directional axis DR1 and the second directional axis DR2. In this specification, the front (or upper) and rear (or lower) surfaces of each component are defined with respect to a direction in which the image IM is displayed. The front and rear surfaces may be opposed to each other in the third directional axis DR3, and the normal direction of each of the front and rear surfaces may be parallel to the third directional axis DR3.

The electronic device ED in an embodiment of the inventive concept may include a first display surface FS and a second display surface RS. The first display surface FS may include an electronic module region EMA. The second display surface RS may be defined as a surface opposed to at least a portion of the first display surface FS. That is, the second display surface RS may be defined as a portion of the rear surface of the electronic device ED.

The electronic device ED in an embodiment of the inventive concept may sense an external input applied from the outside. The external input may include various types of inputs provided from the outside of the electronic device ED. In an embodiment, the external input may include not only a touch by a part of a body such as a user's hand, but also an external input (e.g., hovering) applied at a place close to or at a predetermined close distance from the electronic device ED, for example. In addition, the external input may have various forms, such as force, pressure, temperature, and light.

FIG. 1A and the drawings below illustrate the first directional axis DR1 to the third directional axis DR3, and directions indicated by the first to third directional axes DR1, DR2, and DR3 described in this specification are relative concepts and may be converted into other directions. In addition, the directions indicated by the first to third directional axes DR1, DR2, and DR3 may be described as first to third directions, and the same reference numerals may be used for them.

The first display surface FS of the electronic device ED may include an active region that is activated according to an electrical signal. The electronic device ED in an embodiment of the inventive concept may display an image IM through the first display surface FS. In addition, various types of external inputs may be sensed on the first display surface FS.

The electronic device ED may include a folding region FA1 and non-folding regions NFA1 and NFA2. In an embodiment of the inventive concept, the non-folding regions NFA1 and NFA2 may be disposed next (adjacent) to the folding region FA1 with the folding region FA1 interposed therebetween. The electronic device ED in an embodiment of the inventive concept may include a first non-folding region NFA1 and a second non-folding region NFA2 disposed to be spaced apart from each other in the direction of the first directional axis DR1 with the folding region FA1 interposed therebetween. In an embodiment, the first non-folding region NFA1 may be disposed on one side of the folding region FA1 along the first directional axis (also referred to as a first direction) DR1, and the second non-folding region NFA2 may be disposed on an opposite side of the folding region FA1 along the first direction DR1, for example.

FIGS. 1A to 1C illustrate an embodiment of the electronic device ED including one folding region FA1, but the inventive concept is not limited thereto, and a plurality of folding regions may be defined in the electronic device ED. In an embodiment, the electronic device in an embodiment of the inventive concept may include two or more folding regions and may also include three or more non-folding regions with each of the folding regions interposed therebetween, for example.

Referring to FIG. 1B, the electronic device ED in an embodiment of the inventive concept may be folded with respect to a first folding axis FX1. The first folding axis FX1 is a virtual axis extending in the direction of the second directional axis DR2, and the first folding axis FX1 may be parallel to the long side of the electronic device ED. The first folding axis FX1 may extend along the second directional axis DR2 on the first display surface FS.

The electronic device ED may be folded with respect to the first folding axis FX1 and be transformed into an inner-folded state in which one region of the first display surface FS overlapping the first non-folding region NFA1 and a remaining (the other) region thereof overlapping the second non-folding region NFA2 face each other.

When the electronic device ED in an embodiment of the inventive concept is in an inner-folded state, the second display surface RS may be visible to a user. The second display surface RS may further include an electronic module region in which an electronic module including various components is disposed, and the second display surface RS is not limited to a particular embodiment.

Referring to FIG. 1C, the electronic device ED in an embodiment of the inventive concept may be folded with respect to the first folding axis FX1 and be transformed into an outer-folded state in which one region of the second display surface RS overlapping the first non-folding region NFA1 and a remaining (the other) region thereof overlapping the second non-folding region NFA2 face each other.

However, the inventive concept is not limited thereto, and the electronic device ED may be folded with respect to a plurality of folding axes so that portions of the first display surface FS and the second display surface RS face each other, and the number of folding axes and the number of non-folding regions according thereto are not particularly limited.

Various electronic modules may be disposed in the electronic module region EMA. In an embodiment, an electronic module may include at least any one of a camera, a speaker, a light sensor, or a heat sensor, for example. The electronic module region EMA may sense an external object received through the first or second display surface FS or RS or provide the outside with a sound signal such as voice through the first or second display surface FS or RS. The electronic module may include a plurality of components and is not limited to a particular embodiment. In an embodiment, the electronic device ED may include a display device DD and a housing HAU accommodating the display module DM and a window module WM (refer to FIG. 4).

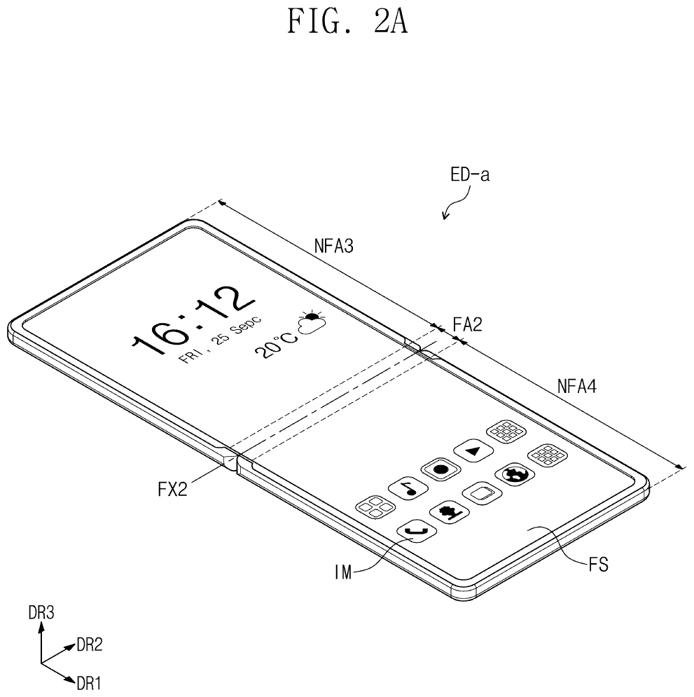

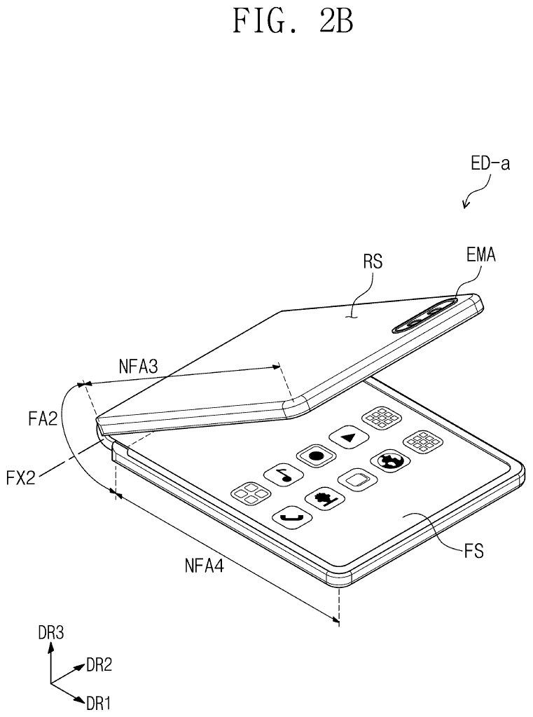

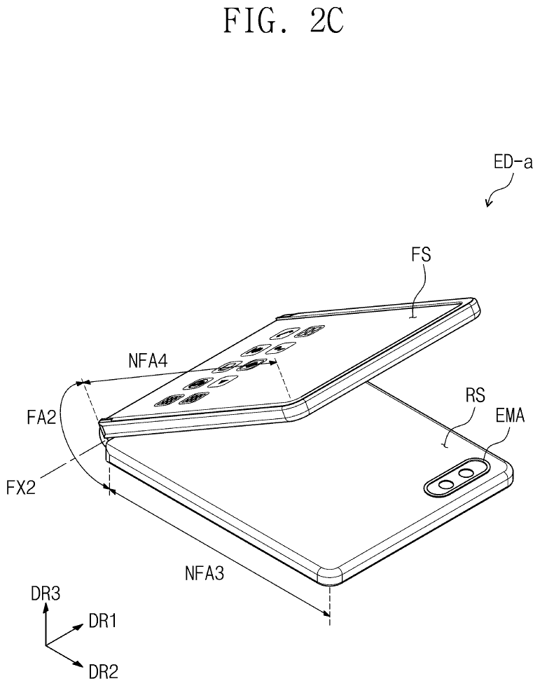

FIG. 2A is a perspective view illustrating an embodiment of an unfolded state of an electronic device according to the inventive concept. FIG. 2B is a perspective view illustrating an in-folding process of the electronic device in an embodiment of the inventive concept illustrated in FIG. 2A. FIG. 2C is a perspective view illustrating an out-folding process of the electronic device in an embodiment of the inventive concept illustrated in FIG. 2A.

An electronic device ED-a in an embodiment of the inventive concept may be folded with respect to a second folding axis FX2 extending in one direction parallel to the second directional axis DR2. FIG. 2B illustrates a case in which the extension direction of the second folding axis FX2 is parallel to the extension direction of the short side of the electronic device ED-a. However, the inventive concept is not limited thereto.

The electronic device ED-a in an embodiment of the inventive concept may include at least one folding region FA2 and non-folding regions NFA3 and NFA4 next (adjacent) to the folding region FA2. The non-folding regions NFA3 and NFA4 may be spaced apart from each other with the folding region FA2 interposed therebetween.

The folding region FA2 has a predetermined curvature and a predetermined curvature radius. In an embodiment of the inventive concept, the first non-folding region NFA3 and the second non-folding region NFA4 may face each other, and the electronic device ED-a may be inner-folded so that the first display surface FS is not exposed to the outside. In addition, referring to FIG. 2C, in an embodiment of the inventive concept, the electronic device ED-a may be outer-folded so that the first display surface FS is exposed to the outside.

The electronic device ED-a in an embodiment of the inventive concept may include a second display surface RS, and the second display surface RS may be defined as a surface opposed to at least a portion of the first display surface FS. The second display surface RS may include an electronic module region EMA in which an electronic module including various components is disposed. In addition, an image or video may be displayed on at least a portion of the second display surface RS.

In an embodiment of the inventive concept, when the electronic device ED-a is in an unfolded state, the first display surface FS may be visible to a user, and when the electronic device ED-a is in an inner-folded state, the second display surface RS may be visible to a user.

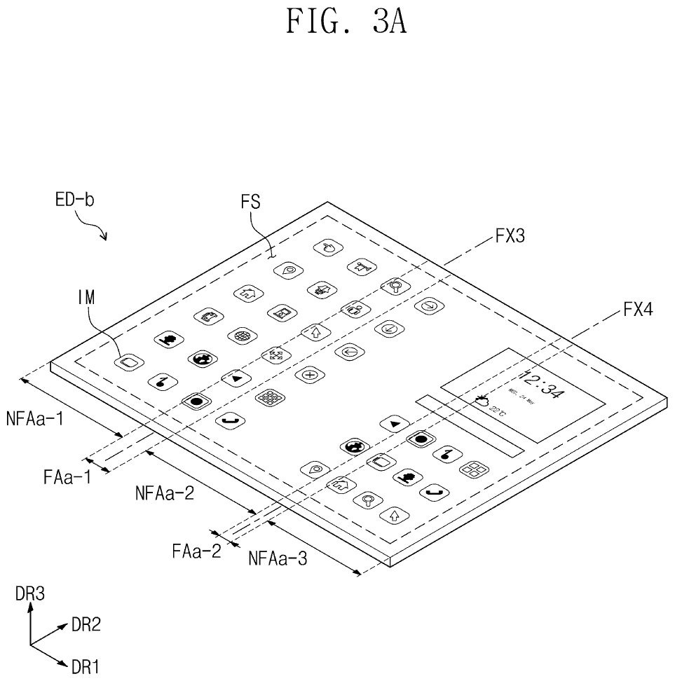

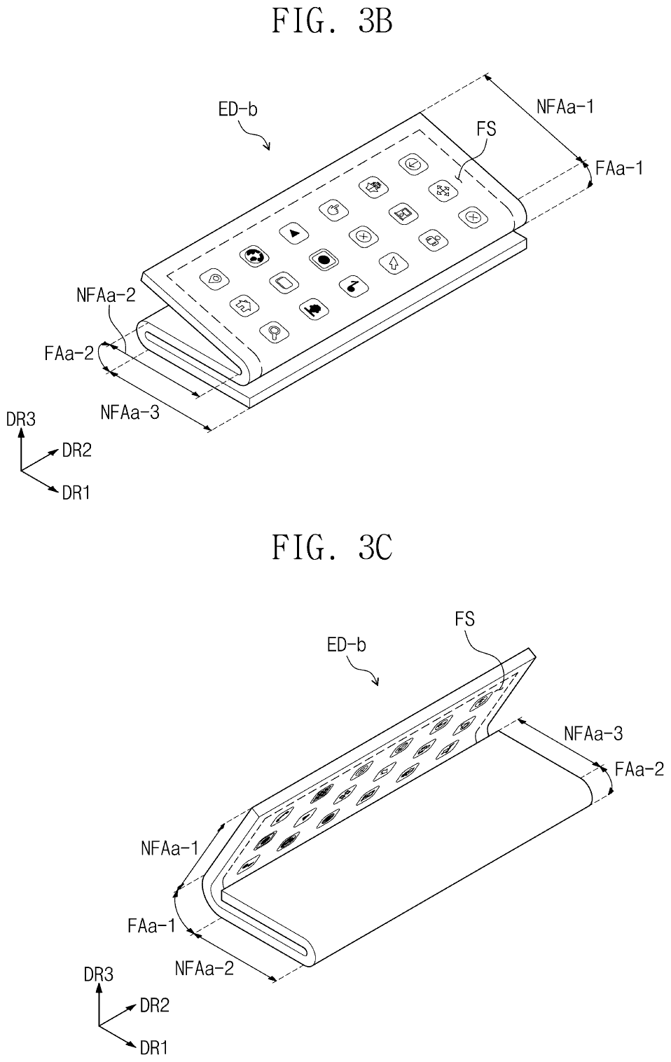

FIG. 3A is a perspective view of an embodiment of an electronic device ED-b according to the inventive concept. Each of FIGS. 3B and 3C is a perspective view illustrating a multi-folded state of the electronic device ED-b illustrated in FIG. 3A

Referring to FIGS. 3A to 3C, the electronic device ED-b in an embodiment of the inventive concept may be a multi-foldable device including a plurality of folding regions. The electronic device ED-b may include a plurality of folding regions FAa-1 and FAa-2 and a plurality of non-folding regions NFAa-1, NFAa-2, and NFAa-3. The electronic device ED-b in an embodiment of the inventive concept may include a first folding region FAa-1, a second folding region FAa-2, a first non-folding region NFAa-1, a second non-folding region NFAa-2, and a third non-folding region NFAa-3. In the first direction DR1, the first folding region FAa-1 is disposed between the first non-folding region NFAa-1 and the second non-folding region NFAa-2, and the second folding region FAa-2 is disposed between the second non-folding region NFAa-2 and the third non-folding region NFAa-3. FIGS. 3A to 3C illustrate two folding regions FAa-1 and FAa-2 and three non-folding regions NFAa-1, NFAa-2, and NFAa-3, but the number of folding regions FAa-1 and FAa-2 and non-folding regions NFAa-1, NFAa-2, and NFAa-3 is not limited thereto and may be further increased.

Referring to FIGS. 3A and 3B, the first folding region FAa-1 may be folded with respect to a third folding axis FX3 parallel to the second directional axis (also referred to as a second direction) DR2. The first folding region FAa-1 may be outer-folded so that the rear surface of the second non-folding region NFAa-2 and the rear surface of the first non-folding region NFAa-1 face each other and the display surface of the first non-folding region NFAa-1 faces the outside. The second folding region FAa-2 may be folded with respect to a fourth folding axis FX4 parallel to the second direction DR2. The second folding region FAa-2 may be inner-folded so that the display surface of the second non-folding region NFAa-2 and the display surface of the third non-folding region NFAa-3 face each other.

Referring to FIGS. 3A and 3C, the second folding region FAa-2 may be folded with respect to the fourth folding axis FX4 parallel to the second direction DR2. The display surface of the second non-folding region NFAa-2 may be inner-folded so that it is disposed inside and faces the display surface of the third non-folding region NFAa-3. The first folding region FAa-1 may be folded with respect to the third folding axis FX3 parallel to the second direction DR2. The first folding region FAa-1 may be inner-folded so that the rear surface of the third non-folding region NFAa-3 and the display surface of the first non-folding region NFAa-1 face each other.

The multi-folded states of the electronic device are not limited to the shapes illustrated in FIGS. 3B and 3C, and the electronic device may have various folding shapes.

In an embodiment of the inventive concept, both an out-folding operation and an in-folding operation may occur simultaneously, and only one of the out-folding operation and the in-folding operation may occur.

In an embodiment of the inventive concept, the electronic devices ED, ED-a, and ED-b may be configured so that in-folding and out-folding operations are alternately repeated from an unfolding operation, but the inventive concept is not limited thereto. In an embodiment of the inventive concept, the electronic devices ED, ED-a, and ED-b may be configured so that any one of an unfolding operation, an in-folding operation, and an out-folding operation is selected. In addition, when a plurality of folding regions are included, the folding direction of at least one of the plurality of folding regions may be different from the folding direction of the remaining folding regions. In an embodiment, when two folding regions are included, two non-folding regions with one folding region interposed therebetween may be folded by an in-folding operation, and two non-folding regions with a remaining (the other) folding region interposed therebetween may be folded by an out-folding operation, for example.

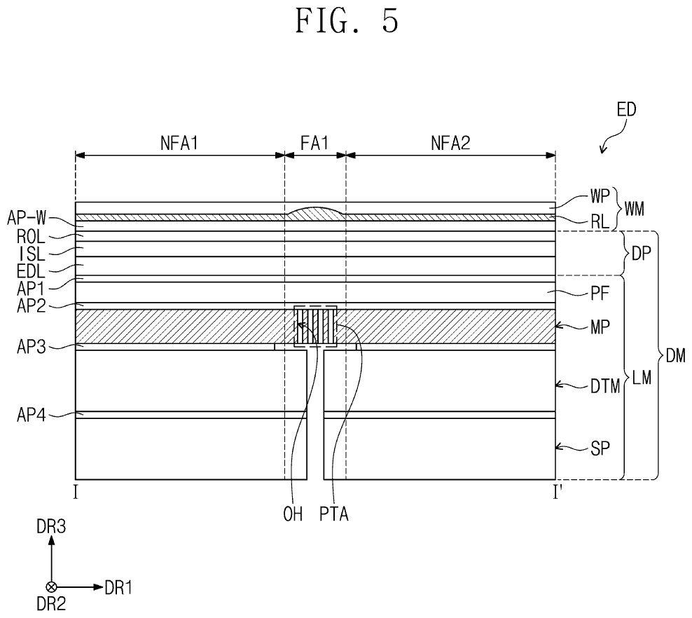

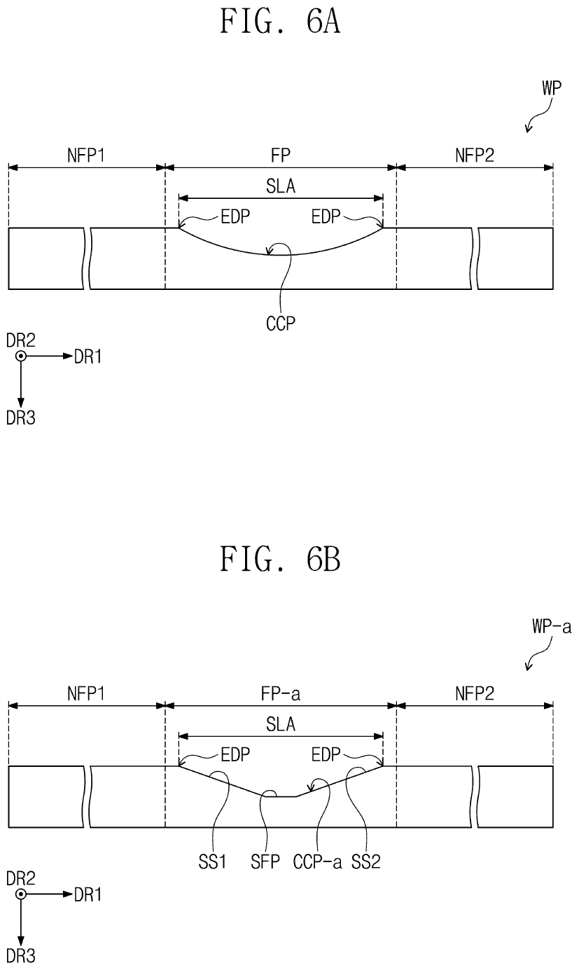

FIG. 4 is an exploded perspective view of an embodiment of an electronic device according to the inventive concept. FIG. 5 is a cross-sectional view illustrating an embodiment of a portion of the electronic device according to the inventive concept. FIG. 5 is a cross-sectional view illustrating a portion corresponding to line I-I′ of FIG. 1A.

FIGS. 4, 5, or the like below illustrate a case in which the first folding axis FX1 of the electronic device ED illustrated in FIG. 1A or the like is parallel to the long side of the electronic device ED, but the inventive concept is not limited thereto, and the content described with reference to the drawings below may also be applied to a case in which the folding axis FX2 is parallel to the short side of the electronic device as illustrated in FIG. 2A or the like, or to a case in which the electronic device is multi-folded as illustrated in FIG. 3A or the like.

The electronic device ED in an embodiment of the inventive concept may include a display module DM, a window module WM, and a housing HAU configured to accommodate the display module DM and the window module WM.

The display module DM may include a display panel DP and a lower module LM disposed below the display panel DP. The lower module LM may include a support plate MP. In addition, in an embodiment of the inventive concept, the display module DM may further include at least one of a protective layer PF, a support member SP, adhesive layers AP1, AP2, AP3, and AP4, or a digitizer module DTM in addition to the support plate MP in the lower module LM.

The display panel DP may display an image according to an electrical signal and transmit/receive information on an external input. The display panel DP may include a display region DP-DA and a non-display region DP-NDA. The display region DP-DA may be defined as a region from which an image provided by the display panel DP is output.

The non-display region DP-NDA is next (adjacent) to the display region DP-DA. In an embodiment, the non-display region DP-NDA may surround the display region DP-DA, for example. However, this is illustrated in an embodiment, and the non-display region DP-NDA may be defined in various shapes and is not limited to a particular embodiment. In addition, the display panel DP may include a non-display bending portion NDA-BP disposed on at least one side of the non-display region DP-NDA. The non-display bending portion NDA-BP may be bent toward the lower side of the display module DM and be disposed to overlap at least a portion of the display panel DP. A circuit layer, a connection line, a circuit board, or the like for displaying an image or transmitting/receiving information may be disposed (e.g., mounted) on or attached to the non-display bending portion NDA-BP.

In an embodiment of the inventive concept, the display panel DP includes a display layer EDL. The display layer EDL may be a component that substantially generates an image. The image generated by the display layer EDL may be viewed by a user from the outside through the first display surface FS (refer to FIG. 1A). The display layer EDL may be a light-emitting display layer, but is not particularly limited thereto. In an embodiment, the display layer EDL may be an organic light-emitting display layer or an inorganic light-emitting display layer, for example. The organic light-emitting display layer may include a light-emitting element including an organic light-emitting material in a light-emitting layer. In addition, the inorganic light-emitting display layer may include a light-emitting element including materials such as quantum dots and quantum rods in a light-emitting layer.

The display panel DP may further include a sensor layer ISL. The sensor layer ISL may be disposed directly on the display layer EDL. The sensor layer ISL may include a plurality of sensing electrodes. The sensor layer ISL may sense an external input by a self-cap method or a mutual cap method. The sensor layer ISL may sense an input by an active-type input device.

The sensor layer ISL may be formed directly on the display layer EDL through a continuous process when the display layer EDL is manufactured. However, the inventive concept is not limited thereto, and the sensor layer ISL may be manufactured as a panel separate from the display layer EDL and then may be attached to the display layer EDL by an adhesive layer (not illustrated).

In addition, the display panel DP may further include an optical layer ROL. The optical layer ROL may function to reduce reflection of external light. In an embodiment, the optical layer ROL may include a polarizing layer or a color filter layer, for example. However, the inventive concept is not limited thereto, and the optical layer ROL may include optical members for improving the display quality of the display module DM.

In an embodiment of the inventive concept, the optical layer ROL may be disposed directly on the sensor layer ISL. In addition, when the sensor layer ISL is omitted from the display panel DP, the optical layer ROL may be disposed directly on the display layer EDL. However, the inventive concept is not limited thereto, and the optical layer ROL may be disposed on the display layer EDL or the sensor layer ISL using a separate adhesive member.

The display panel DP may include a folding display portion FP-D and non-folding display portions NFP1-D and NFP2-D. The folding display portion FP-D may correspond to the folding region FA1 (refer to FIG. 1A), and the non-folding display portions NFP1-D and NFP2-D may correspond to the non-folding regions NFA1 and NFA2 (refer to FIG. 1A). The folding display portion FP-D and the non-folding display portions NFP1-D and NFP2-D of the display panel DP may be respectively referred to as the folding display portion and the non-folding display portion of the display module DM.

The folding display portion FP-D may correspond to a portion that is folded or bent with respect to the first folding axis FX1 (refer to FIG. 1A). The display panel DP may include a first non-folding display portion NFP1-D and a second non-folding display portion NFP2-D, and the first non-folding display portion NFP1-D and the second non-folding display portion NFP2-D may be spaced apart from each other in the first direction DR1 with the folding display portion FP-D interposed therebetween. The folding display portion FP-D may correspond to the folding region FA1 of the electronic device ED, and the first non-folding display portion NFP1-D and the second non-folding display portion NFP2-D may respectively correspond to the first non-folding region NFA1 and the second non-folding region NFA2 of the electronic device ED.

In an embodiment of the inventive concept, the support plate MP may be disposed below the display panel DP. The support plate MP may include a folding support portion FP-MP and non-folding support portions NFP1-MP and NFP2-MP. A first non-folding support portion NFP1-MP and a second non-folding support portion NFP2-MP of the support plate MP may be spaced apart from each other in the first direction DR1 with the folding support portion FP-MP interposed therebetween. The folding support portion FP-MP may correspond to the folding region FA1 (refer to FIG. 1A), and the non-folding support portions NFP1-MP and NFP2-MP may correspond to the non-folding regions NFA1 and NFA2 (refer to FIG. 1A). The support plate MP may include a pattern portion PTA in which a plurality of openings OH are defined. The pattern portion PTA may be included in the folding support portion FP-MP. The folding or bending characteristics of the electronic device ED may be improved by disposing the pattern portion PTA so as to correspond to the folding region FA1.

In the display module DM in an embodiment of the inventive concept, the protective layer PF of the lower module LM may be disposed between the display panel DP and the support plate MP. The protective layer PF may be disposed below the display panel DP to protect the rear surface of the display panel DP. The protective layer PF may overlap the entirety of the display panel DP. The protective layer PF may include a polymer material. In an embodiment, the protective layer PF may be a polyimide film or a polyethylene terephthalate film, for example. However, this is an illustrative embodiment and the material of the protective layer PF is not limited thereto.

In an embodiment of the inventive concept, the lower module LM may include a support member SP. The support member SP may include support layers SP1 and SP2. The support layers SP1 and SP2 may include a first support layer SP1 and a second support layer SP2 spaced apart from each other in the direction of the first directional axis DR1. The first support layer SP1 and the second support layer SP2 may be spaced apart from each other in a portion corresponding to the first folding axis FX1 (refer to FIG. 1A). As the support layers SP1 and SP2 are spaced apart from each other in the folding region FA1 and are provided as the first support layer SP1 and the second support layer SP2, it is possible to improve the folding or bending characteristics of the electronic device ED. Although not illustrated, the support layers SP1 and SP2 may further include a cushion layer (not illustrated) and a lower support plate (not illustrated) stacked in the thickness direction.

The electronic device ED in an embodiment of the inventive concept may further include a digitizer module DTM disposed below the support plate MP. The digitizer module DTM in an embodiment of the inventive concept may include a digitizer layer, a shielding layer, or the like. The digitizer module DTM may be included in the configuration of the lower module LM.

The digitizer module DTM may include a first digitizer module DTM1 and a second digitizer module DTM2 disposed to be spaced apart from each other in a portion overlapping the folding region FA1. The first digitizer module DTM1 may be disposed to correspond to the first non-folding region NFA1, and the second digitizer module DTM2 may be disposed to correspond to the second non-folding region NFA2.

That is, in an embodiment of the inventive concept, the first digitizer module DTM1 and the second digitizer module DTM2 may be spaced apart from each other in a region overlapping the folding display portion FP-D. The first digitizer module DTM1 may overlap the first non-folding display portion NFP1-D, and the second digitizer module DTM2 may overlap the second non-folding display portion NFP2-D.

In addition, the electronic device ED in an embodiment of the inventive concept may further include at least one of adhesive layers AP1, AP2, AP3, and AP4. In an embodiment, a first adhesive layer AP1 may be disposed between the display panel DP and the protective layer PF, and a second adhesive layer AP2 may be disposed between the protective layer PF and the support plate MP. A third adhesive layer AP3 and a fourth adhesive layer AP4 may be disposed between the support plate MP and the support member SP, for example. At least one of the adhesive layers AP1, AP2, AP3, and AP4 may be an optically transparent adhesive film or an optically transparent adhesive resin layer. However, the inventive concept is not limited thereto, and at least one of the adhesive layers AP1, AP2, AP3, and AP4 may have a relatively low transmittance of about 80% or less.

FIGS. 4, 5, or the like illustrate that the lower module LM includes all of the protective layer PF, the support plate MP, the support member SP, the adhesive layers AP1, AP2, AP3, and AP4, and the digitizer module DTM, but the embodiment of the inventive concept is not limited to what is illustrated, and the configuration of the lower module LM may include only some of the components listed above in consideration of the mechanical properties, shapes, and operating characteristics desired for the electronic device ED, or more components may be added in addition to the components of the lower module presented above.

The electronic device ED in an embodiment of the inventive concept includes a window module WM disposed on the display module DM. In an embodiment, the electronic device ED may further include a window adhesive layer AP-W disposed between the display module DM and the window WM, but is not limited thereto. The window module WM may include a folding portion FP-W and non-folding portions NFP1-W and NFP2-W. A first non-folding portion NFP1-W and a second non-folding portion NFP2-W of the window module WM may be spaced apart from each other in the first direction DR1 with the folding portion FP-W interposed therebetween. The folding portion FP-W may correspond to the folding region FA1 of the electronic device ED (refer to FIG. 1A), and the non-folding portions NFP1-W and NFP2-W may correspond to the non-folding regions NFA1 and NFA2. In addition, the folding portion FP-W may correspond to the folding display portion FP-D, and the non-folding portions NFP1-W and NFP2-W may correspond to the non-folding display portions NFP1-D and NFP2-D.

The window module WM may cover the entirety of the upper surface of the display module DM. In an embodiment of the inventive concept, the window module WM may be used as a cover window of the electronic device ED. In an embodiment of the inventive concept, the window module WM may correspond to the uppermost member of the electronic device ED.

In an embodiment of the inventive concept, the window module WM may include a window glass WP and a resin layer RL. The resin layer RL may be disposed on the upper surface or lower surface of the window glass WP. In the drawings of this specification, the resin layer RL is illustrated as being disposed on the lower surface of the window glass WP, but the inventive concept is not limited thereto, and the resin layer RL may be disposed on the upper surface of the window glass WP, or the resin layer RL may be disposed to cover the upper and side surfaces of the window glass WP. In this specification, the window glass WP may also be also referred to as a window WP, and the window glass manufacturing device may be also referred to as a window manufacturing device.

In an embodiment of the inventive concept, the resin layer RL may include or consist of an organic resin. In addition, unlike this, the resin layer RL may include or consist of a composite resin including both an organic material and an inorganic material.

In an embodiment of the inventive concept, the window WP may be a tempered glass substrate. The window WP may be an ultra-thin tempered glass substrate. The window WP may be flexible enough to change its state easily by folding or bending.

In an embodiment of the inventive concept, the window WP may include a slimming region having a smaller average thickness than remaining (the other) portions, and the slimming region may be disposed to correspond to the folding region FA1 of the electronic device. FIG. 5 illustrates the electronic device ED including one folding region FA1, but when a plurality of folding regions are included therein, the window WP may include slimming regions respectively corresponding to the folding regions. As the slimming region is included in the window WP, the electronic device ED may exhibit excellent folding or bending operation characteristics.

Each of FIG. 6A and FIG. 6B is a cross-sectional view of an embodiment of a window glass according to the inventive concept. Windows WP and WP-a illustrated in FIGS. 6A and 6B differ in the shapes of recessed areas CCP and CCP-a defined in a slimming region SLA.

The window WP or WP-a in an embodiment of the inventive concept may include a folding portion FP or FP-a and a first non-folding portion NFP1 and a second non-folding portion NFP2 spaced apart from each other in the first direction DR1 with the folding portion FP or FP-a interposed therebetween.

The recessed area CCP or CCP-a may be defined by being concavely recessed from at least one of the upper or lower surface of the window. The recessed area CCP or CCP-a may be defined in the folding portion FP or FP-a. In FIG. 5, the recessed area CCP or CCP-a of the window WP or WP-a is illustrated as being disposed in a direction away from the upper surface of the display panel DP, but the inventive concept is not limited thereto, and in an embodiment of the inventive concept, the window WP or WP-a may be disposed so that the recessed area CCP or CCP-a is concavely recessed in the direction of the display panel DP.

The slimming region SLA in which the recessed area CCP or CCP-a is formed corresponds to a portion that is relatively thinner than the first non-folding portion NFP1 and the second non-folding portion NFP2 of the window. The recessed area CCP or CCP-a may be formed in a shape that extends in the second direction DR2. The extension direction of the recessed area CCP or CCP-a may correspond to the extension direction of the first folding axis FX1 (refer to FIG. 4).

An edge portion EDP of the recessed area CCP or CCP-a that is the boundary of the slimming region SLA may be a portion corresponding to a boundary region to which an etching solution is provided in a window manufacturing method in an embodiment of the inventive concept, which will be described later. In the window WP or WP-a in an embodiment of the inventive concept, the width and position of the slimming region SLA may be changed according to the folding or bending characteristics desired for the electronic device. The width and position of the slimming region SLA may be controlled according to the position of the nozzle portion configured to supply the etching solution, the supply form of the etching solution, etc. in the window manufacturing device and the window manufacturing method in an embodiment of the inventive concept, which will be described later.

Referring to FIG. 6A, the recessed area CCP of the window WP in an embodiment of the inventive concept may include a curved surface having a predetermined curvature radius. The recessed area CCP may have a concave shape with respect to a flat surface which is the upper surface of the first non-folding portion NFP1 and the second non-folding portion NFP2. The recessed area CCP or CCP-a may be defined as a continuous curved surface shape extending in the second direction DR2 between the first non-folding portion NFP1 and the second non-folding portion NFP2 spaced apart from each other in the first direction DR1. The upper surface of the exposed recessed area CCP or CCP-a in the window WP or WP-a manufactured by the window manufacturing device in an embodiment of the inventive concept and the window manufacturing method in an embodiment of the inventive concept, which will be described later, may include a smooth curved surface without a discontinuity.

Referring to FIG. 6B, the recessed area CCP-a of the window WP-a in an embodiment of the inventive concept may include inclined surfaces SS1 and SS2. The recessed area CCP-a may have a concavely recessed shape with respect to a flat surface which is the upper surface of the first non-folding portion NFP1 and the second non-folding portion NFP2. The recessed area CCP-a may include a recessed-area flat surface SFP and a first inclined surface SS1 and a second inclined surface SS2 spaced apart from each other in the first direction DR1 with the recessed-area flat surface SFP interposed therebetween. The recessed-area flat surface SFP and the inclined surfaces SS1 and SS2 may be defined as a continuous flat and inclined surface shape extending in the second direction DR2. The first inclined surface SS1, the recessed-area flat surface SFP, and the second inclined surface SS2 may be continuous surfaces without a discontinuity. The first inclined surface SS1, the recessed-area flat surface SFP, and the second inclined surface SS2 may be next (adjacent) and connected to each other. The boundary portions of the first inclined surface SS1 and the recessed-area flat surface SFP and the boundary portions of the recessed-area flat surface SFP and the second inclined surface SS2 may be smoothly connected to each other without a discontinuity or step difference, so that the upper surface of the recessed area CCP-a may have a continuous surface.

The shapes of the recessed areas CCP and CCP-a of the windows WP and WP-a illustrated in FIGS. 6A and 6B are exemplary, and the shapes of the recessed areas CCP and CCP-a may be changed according to folding or bending characteristics desired for an electronic device or the like. In an embodiment, depending on the folding or bending characteristics desired for an electronic device, the radius of curvature in the recessed area CCP having a curved shape may be changed, and the inclination angle or length of the inclined surfaces SS1 and SS2 in the recessed area CCP-a including the inclined surfaces and the width of the recessed-area flat surface SFP between the inclined surfaces SS1 and SS2 may be changed, for example.

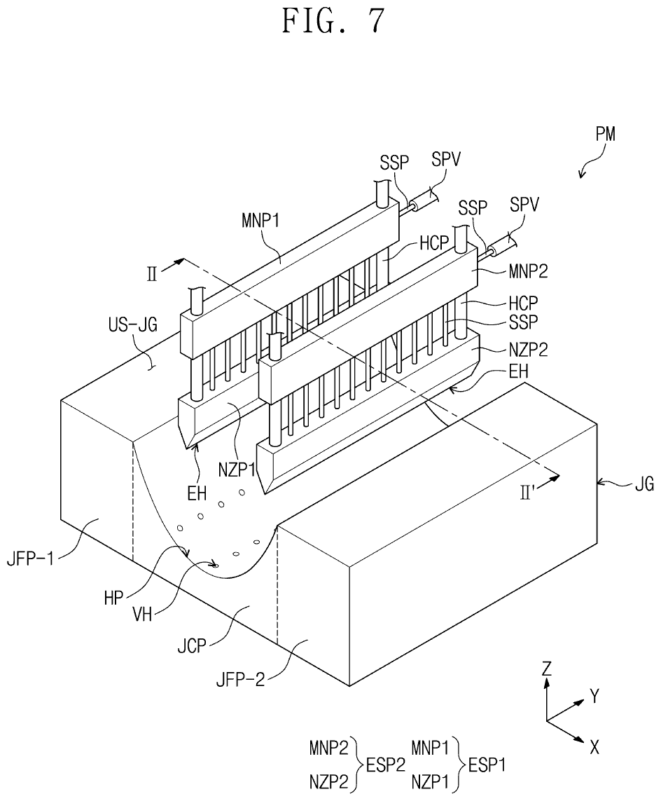

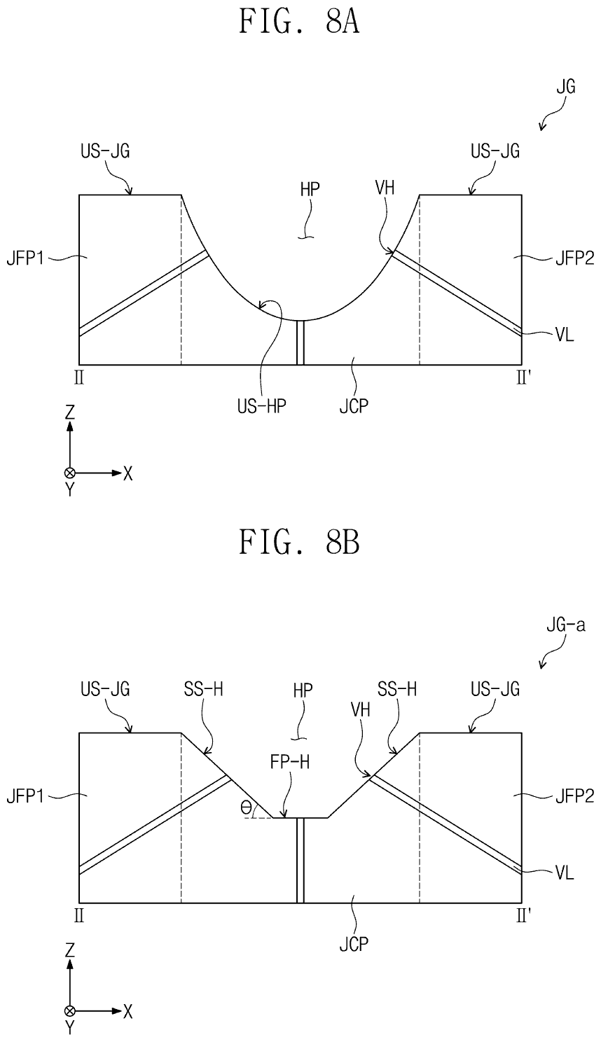

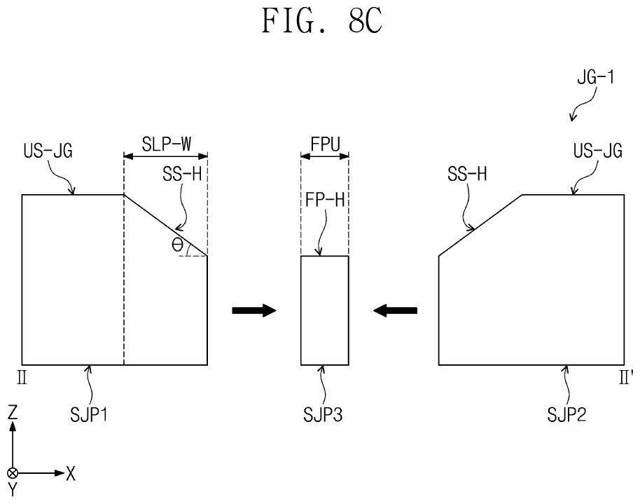

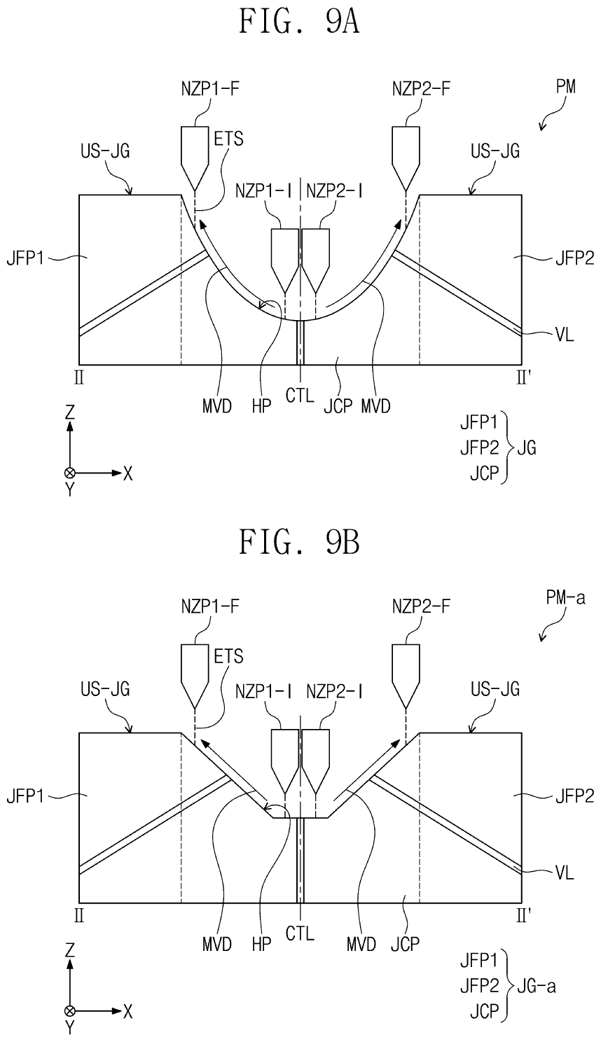

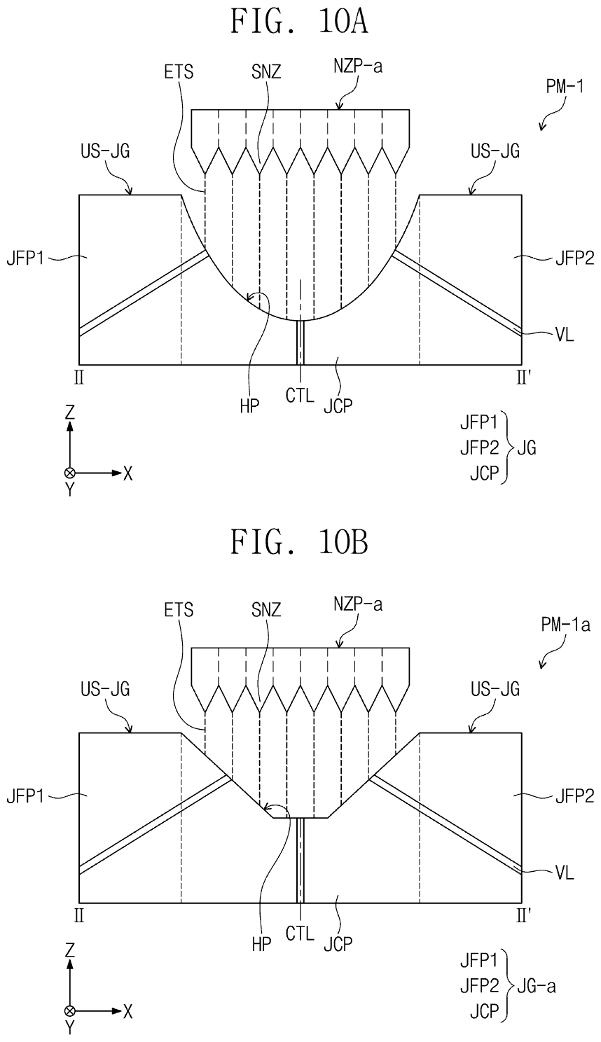

FIG. 7 is a perspective view of an embodiment of a window glass manufacturing device according to the inventive concept. The window glass manufacturing device may be also referred to as a window manufacturing device. The window manufacturing device PM in an embodiment of the inventive concept may include a base jig JG and etching solution supply units ESP1 and ESP2 disposed above the base jig JG. The etching solution supply unit ESP1 or ESP2 may include a nozzle portion NZP1 or NZP2 having a discharge outlet EH exposed in the direction of the base jig JG. In FIG. 7, the window manufacturing device PM in an embodiment of the inventive concept is illustrated as including two separate nozzle portions NZP1 and NZP2, but the inventive concept is not limited thereto, and the window manufacturing device PM in an embodiment of the inventive concept may include either only one nozzle portion that does not move in position, or three or more nozzle portions that are separated from each other and may be controlled to move in position.

In an X-axis X, a Y-axis Y, and a Z-axis Z illustrated in FIG. 7 and the drawings below, a direction corresponding to the Z-axis Z is defined as an upward direction. In addition, the X-axis X and the Y-axis Y are orthogonal to each other, and the Z-axis Z may be a normal direction of a plane defined by the X-axis X and the Y-axis Y.

The X-axis X may correspond to the first direction DR1 illustrated in the drawings described above, the Y-axis Y may correspond to the second direction DR2 illustrated in the drawings described above, and the Z-axis Z may correspond to the third direction DR3 illustrated in the drawings described above.

In the window manufacturing device PM in an embodiment of the inventive concept, the base jig JG may include a groove area HP on which a workpiece is seated. The groove area HP of the base jig JG may be formed to extend in one direction. The base jig JG may be a fixing jig for fixing a workpiece during a manufacturing operation. A plurality of vacuum suction inlets VH may be defined in the upper surface of the base jig JG. By using a vacuum state provided by the vacuum suction inlets VH, a workpiece, such as base glass, may be fixed to the groove area HP. In the groove area HP of the base jig JG, a portion of the base glass, which is provided as a workpiece and desired to be processed into a slimming region, may be disposed.

The base jig JG may be divided into a central portion JCP including a groove area HP and a first support portion JFP-1 and a second support portion JFP-2 spaced apart from each other in a direction corresponding to the X-axis X, which is one direction, with the central portion JCP interposed therebetween. An upper surface US-JG of the base jig JG may include a flat surface and a curved surface or an inclined surface.

The upper surface of the central portion JCP may include a curved surface or an inclined surface, and the upper surfaces of the first support JFP-1 and the second support JFP-2 may be flat surfaces. The groove area HP of the base jig JG may include a curved surface having a curvature, or an inclined surface formed to have an inclination angle with respect to a flat surface which is the upper surface of the first support portion JFP-1 or the second support portion JFP-2. A workpiece may be provided to the groove area HP of the base jig JG in a deformed shape so as to have a curvature or a predetermined angle and may be fixed to have a shape corresponding to the shape of the groove area HP of the base jig JG.

The etching solution supply unit ESP1 or ESP2 may include a nozzle portion NZP1 or NZP2 that sprays the etching solution toward the base jig JG and a motion control portion MNP1 or MNP2 that moves the nozzle portion NZP1 or NZP2. In addition, the etching solution supply unit ESP1 or ESP2 may include a sub-etching solution supply line SSP, which is connected to a supply line SPV configured to supply the etching solution from the outside and distributes and supplies the etching solution to the nozzle portion NZP1 or NZP2.

The motion control portion MNP1 or MNP2 may control the etching solution supply unit ESP1 or ESP2 so that it may move in the upward/downward direction (also referred to as a first moving direction) and the left/right direction (also referred to as a second moving direction). Referring to FIG. 7 or the like, the upward/downward direction may correspond to a direction parallel to the Z-axis Z, and the left/right direction may correspond to a direction parallel to the X-axis X. The motion control portion MNP1 or MNP2 may control the nozzle portion NZP1 or NZP2 so that it may move along the shape of the groove area HP of the base jig JG or the shape of the upper surface of the workpiece disposed in the groove area HP.

The etching solution supply unit ESP1 or ESP2 may further include a height adjustment part HCP. The vertical position of the nozzle portion NZP1 or NZP2 may be adjusted by the height adjustment part HCP.

The position of the etching solution supply unit ESP1 or ESP2 above the base jig JG may be adjusted by the motion control portion MNP1 or MNP2, and the distance between the discharge outlet EH of the nozzle portion NZP1 or NZP2 and the upper surface of the groove area HP of the base jig JG may be adjusted by the height adjustment part HCP.

The nozzle portion NZP1 or NZP2 may include a discharge outlet EH formed to extend in a direction corresponding to the Y-axis Y. Although not illustrated, the discharge outlet EH may be defined as a single line along the extension direction of the nozzle portion NZP1 or NZP2, or may have a shape in which multiple sub-discharge outlets are arranged along the extension direction of the nozzle portion NZP1 or NZP2.

In order to uniformly provide the etching solution onto the workpiece and prevent the etching solution from splashing to a region of the workpiece, which does not desire etching, the method of providing the etching solution with the use of the nozzle portion NZP1 or NZP2, the amount or pressure of the etching solution sprayed, or the like may be controlled. In an embodiment of the inventive concept, the nozzle portion NZP1 or NZP2 may provide the etching solution by a spray method, a flow method, or the like.

In the window manufacturing device PM in an embodiment of the inventive concept, the nozzle portion NZP1 or NZP2 may be controlled to move within a region corresponding to the groove area HP. Even when the nozzle portion NZP1 or NZP2 operates along the shape of the groove area HP, the etching solution supply unit ESP1 or ESP2 may be disposed within a region corresponding to the groove area HP of the base jig JG. Accordingly, even in the operation of etching base glass, which is a workpiece, using the etching solution supply unit ESP1 or ESP2, other portions of the workpiece, which are not disposed in the groove area HP, may be maintained in a state in which they are unaffected by the etching solution supply unit ESP1 or ESP2.

Each of FIG. 8A and FIG. 8B is a cross-sectional view illustrating an embodiment of a base jig in the window manufacturing device according to the inventive concept. Each of FIGS. 8A and 8B may be a cross-sectional view of a base jig in an embodiment of the inventive concept in a portion corresponding to line II-II′ of FIG. 7.

The groove area HP of the base jig JG in an embodiment of the inventive concept illustrated in FIG. 8A has a continuous curved surface shape. A workpiece may be fixed in a deformed form along the shape of the upper surface US-HP of the groove area HP of the base jig. That is, the workpiece may be processed by etching one exposed surface in a fixed state of having a curved shape. In a window in an embodiment of the inventive concept manufactured by being fixed to the base jig JG in an embodiment of the inventive concept illustrated in FIG. 8A, the recessed area of the slimming region SLA may have a continuous curved surface, as illustrated in FIG. 6A.

A groove area HP of a base jig JG-a in an embodiment of the inventive concept illustrated in FIG. 8B may include an inclined surface SS-H. The groove area HP may include a groove area flat surface FP-H, which is parallel to the upper surface US-JG of the jig, and an inclined surface SS-H having a predetermined inclination angle θ with respect to the groove area flat surface FP-H. The inclined surfaces SS-H disposed on opposite sides with the groove area flat surface FP-H interposed therebetween may have shapes that are symmetrical to each other with respect to the groove area flat surface FP-H. The inclination angle θ of the inclined surface SS-H may be about 10 degrees or more. The inclination angle θ of the inclined surface SS-H may be between about 10 degrees and about 45 degrees. An inclination angle of an inclined surface in a manufactured window may be determined according to the inclination angle θ of the inclined surface SS-H.

When a workpiece is placed on the base jig JG-a in an embodiment of the inventive concept, the workpiece may be fixed in a deformed shape along the shape of the upper surface US-HP of the groove area defined by the inclined surface SS-H and the groove area flat surface FP-H. That is, the workpiece may be processed by etching one exposed surface in a fixed state in which it has a shape including the inclined surface SS-H. In a window in an embodiment of the inventive concept which is manufactured by being fixed to the base jig JG-a in an embodiment of the inventive concept as illustrated in FIG. 8B, the recessed area of the slimming region SLA may have continuous surfaces on which the inclined surface, the flat surface, and the inclined surface are connected to each other, as illustrated in FIG. 6B. The inclined surfaces SS1 and SS2 of the window WP-a manufactured by being fixed to the base jig JG-a in an embodiment of the inventive concept as illustrated in FIG. 8B may be formed to have an inclination angle of 0.1 degree or more with respect to the recessed-area flat surface SFP.

Referring to FIGS. 8A and 8B, the vacuum suction inlet VH may be defined in one surface of the groove area HP on which the workpiece is seated. The vacuum suction inlet VH may be connected to a vacuum line VL disposed inside the base jig JG and defined in the upper surface of the groove area HP. Although not illustrated, the vacuum line VL may be connected to a vacuum pump or the like and adsorb and secure the workpiece seated on the base jig JG.

What is illustrated in each of FIGS. 8A and 8B may be a fixed jig in which the shape of the groove area HP is fixed. When manufacturing a window using the base jig JG or JG-a in an embodiment of the inventive concept illustrated in FIG. 8A or FIG. 8B, the window manufacturing device PM (refer to FIG. 7) in an embodiment of the inventive concept may eventually be used by replacing the base jig with one that has a groove area reflecting the shape of the recessed area desired for the window.

FIG. 8C illustrates an embodiment of a base jig according to the inventive concept. FIG. 8C may be a cross-sectional view illustrating a separated shape of a base jig in a portion corresponding to line II-II′ of FIG. 7.

FIG. 8C illustrates a separated cross-sectional view of a base jig JG-1 in a state in which it is divided into a plurality of sub-jig portions SJP1, SJP2, and SJP3. The base jig JG-1 in an embodiment of the inventive concept may be provided by assembling the plurality of sub-jig portions SJP1, SJP2, and SJP3.

The base jig JG-1 may include a first sub-jig portion SJP1 and a second sub-jig portion SJP2, which include an inclined surface SS-H, and a third sub-jig portion SJP3 disposed between the first sub-jig portion SJP1 and the second sub-jig portion SJP2 and including a groove area flat surface FP-H. According to the shape of the slimming region desired for the window, the sub-jig portions SJP1, SJP2, and SJP3 constituting the base jig JG-1 may be selected and assembled. That is, the base jig JG-1 in an embodiment of the inventive concept may be a variable jig that may be assembled and provided so as to reflect the shape of the slimming region of the window being manufactured.

Considering the width of the recessed-area flat surface SFP (refer to FIG. 6B) desired for the window, a width FPU of the groove area flat surface FP-H of the base jig JG-1 may be selected. That is, considering the width of the recessed-area flat surface SFP (refer to FIG. 6B), the third sub-jig portion SJP3 constituting the base jig JG-1 in an embodiment of the inventive concept may be selected and assembled.

In addition, considering the width of the first inclined surface SS1 (refer to FIG. 6B) in one direction desired for the window and the inclination angle of the first inclined surface SS1 (refer to FIG. 6B), the first sub-jig portion SJP1 and the second sub-jig portion SJP2 having a predetermined width SLP-W of the inclined surface SS-H and an inclination angle θ of the inclined surface SS-H may be selected and assembled.

FIG. 8C illustrates three sub-jig portions SJP1, SJP2, and SJP3 which are assembled together to constitute the base jig JG-1, but the inventive concept is not limited thereto. In an embodiment, a variable jig may include two sub-jig portions that are separated from each other, or may include five or more sub-jig portions by separating portions including a flat surface and portions including an inclined surface from the support portions JFP1 and JFP2 (refer to FIG. 8B), for example.

In addition, even when the groove area has a curved surface, considering the shape of the desired curved surface, a portion of the base jig may be separated from remaining (the other) portions and replaced with a sub-jig portion having a different curved surface shape, which may then be assembled with remaining (the other) portions.

Each of FIGS. 9A and 9B illustrates a portion of a window manufacturing device according to the inventive concept. Each of FIGS. 9A and 9B may be a cross-sectional view of a portion of a window manufacturing device, which corresponds to line II-II′ of FIG. 7.

FIG. 9A illustrates a window manufacturing device PM including the base jig JG illustrated in FIG. 8A, and FIG. 9B illustrates a window manufacturing device PM-a including the base jig JG-a illustrated in FIG. 8B.

Referring to FIGS. 7 to 9B, the window manufacturing device PM or PM-a in an embodiment of the inventive concept may include a first nozzle portion NZP1 and a second nozzle portion NZP2 spaced apart from each other with respect to the center of the base jig JG or JG-a.

The first nozzle portion NZP1 and the second nozzle portion NZP2 may be controlled to move in opposite directions with respect to a virtual center line CTL. In an embodiment of one operation of the window manufacturing device PM in an embodiment of the inventive concept, each of the first nozzle portion NZP1 and the second nozzle portion NZP2 may be controlled to move from an initial state NZP1-I or NZP2-I to an end state NZP1-F or NZP2-F. The first nozzle portion NZP1 and the second nozzle portion NZP2 may be controlled to move in a moving direction MVD above one surface of the groove area of the base jig JG.

When the first nozzle portion NZP1 and the second nozzle portion NZP2 are controlled to operate along the moving direction MVD, by positioning the first nozzle portion NZP1 and the second nozzle portion NZP2 within the groove area HP, other portions of the workpiece, which are not disposed in the groove area HP, may be maintained in a state in which they are unaffected by the etching solution ETS even in the operation of etching the base glass, which is the workpiece, using the first nozzle portion NZP1 and the second nozzle portion NZP2.

Each of the first nozzle portion NZP1 and the second nozzle portion NZP2 may continuously provide the etching solution ETS onto the workpiece by starting the provision of the etching solution ETS in the initial state NZP1-I or NZP2-I and progressing toward the end state NZP1-F or NZP2-F. While progressing from the initial state NZP1-I or NZP2-I to the end state NZP1-F or NZP2-F, the etching solution ETS provided by each of the first nozzle portion NZP1 and the second nozzle portion NZP2 flows along the curved surface or the inclined surface within the groove area HP. Accordingly, the region of the workpiece disposed below the starting point position in the initial state NZP1-I or NZP2-I is provided with a larger amount of etching solution ETS and is exposed to the etching solution ETS for a longer time than the region of the workpiece disposed below the end state NZP1-F or NZP2-F. Accordingly, the region of the workpiece disposed below the starting point position in the initial state NZP1-I or NZP2-I receives a larger amount of etching solution than the region of the workpiece disposed below the end state NZP1-F or NZP2-F, and the surface of the window in a processed state has a recessed area defined therein and having a smooth curve or slope.

The point of the end state NZP1-F or NZP2-F may be a portion corresponding to the edge portion EDP of the slimming region SLA of the window in an embodiment of the inventive concept illustrated in FIGS. 6A and 6B. That is, considering the width of the slimming region SLA desired for the window, the point of the end state NZP1-F or NZP2-F at which the nozzle portion NZP1 or NZP2 is finally disposed may be adjusted.

In addition, in the window manufacturing device PM or PM-a in an embodiment of the inventive concept, the shape of the recessed area CCP or CCP-a (refer to FIGS. 6A and 6B) may be controlled by adjusting the moving speed of the nozzle portion NZP1 or NZP2 and the amount of etching solution ETS provided from the nozzle portion NZP1 or NZP2.

Each of FIGS. 10A and 10B illustrates a portion of a window manufacturing device according to the inventive concept. Each of FIGS. 10A and 10B may be a cross-sectional view of a portion of a window manufacturing device, which corresponds to line II-II′ of FIG. 7.

FIG. 10A illustrates a window manufacturing device PM-1 including the base jig JG illustrated in FIG. 8A, and FIG. 10B illustrates a window manufacturing device PM-la including the base jig JG-a illustrated in FIG. 8B.

A nozzle portion NZP-a included in the window manufacturing device PM-1 or PM-la in an embodiment of the inventive concept may include a plurality of sub-nozzle portions SNZ. The plurality of sub-nozzle portions SNZ may be arranged in the direction corresponding to the X-axis X which is the first direction. Each of the plurality of sub-nozzle portions SNZ may include a discharge outlet exposed in the direction of the base jig. The plurality of sub-nozzle portions SNZ may be arranged in a state in which only discharge outlets are separated from each other within one nozzle portion NZP-a, or may be arranged adjacently in the first direction DR1 in a state in which the plurality of divided sub-nozzle portions SNZ are separated from each other.

In an embodiment of the inventive concept, the open and closed states (or on-off states) of the sub-nozzle portions SNZ, or the discharge amounts of the etching solution discharged from the sub-nozzle portions SNZ may be independently controlled. The amount of the etching solution ETS discharged from each of the sub-nozzle portions SNZ and provided to a portion of the workpiece at a corresponding position in direction corresponding to the Z-axis Z may be adjusted according to the shape of the recessed area desired for the window. According to the shape of the recessed area CCP or CCP-a (refer to FIGS. 6A and 6B) of the finally desired window, the time for starting the provision of the etching solution ETS in a state in which the sub-nozzle portions SNZ are open, the interval of time for changing each of the sub-nozzle portions SNZ to an open state, the time for continuously providing the etching solution ETS from each of the sub-nozzle portions SNZ, the spray pressure for providing the etching solution ETS from each of the sub-nozzle portions SNZ, or the like may be adjusted.

The width of the nozzle portion NZP-a in one direction (corresponding to the X-axis X) may be less than or equal to the width of the central portion JCP of the base jig JG or JG-a in one direction. By positioning the nozzle portion NZP-a within the groove area HP, other portions of the workpiece, which are not disposed in the groove area HP, may be maintained in a state in which they are unaffected by the etching solution ETS even in the operation of etching the base glass, which is a workpiece, using the nozzle portion NZP-a.

A position to which the etching solution ETS is provided from the sub-nozzle portions SNZ disposed at the outermost side with respect to the virtual center line CTL among the sub-nozzle portions SNZ may correspond to the edge portion EDP of the slimming region SLA of the window in an embodiment of the inventive concept illustrated in FIGS. 6A and 6B.

That is, the open or closed state of the sub-nozzle portions SNZ of the nozzle portion NZP-a may be adjusted considering the width of the slimming region SLA desired for the window. In addition, the width of the entirety of the nozzle portion NZP-a may be adjusted considering the width of the slimming region SLA desired for the window.

By sequentially changing the closed state of the sub-nozzle portions SNZ to the open state, the etching solution ETS may be sequentially provided, or by controlling the amount of etching solution ETS provided from each of the sub-nozzle portions SNZ, or by controlling the time for maintaining the open state of the sub-nozzle portions SNZ individually, the time for which the etching solution is provided and the amount of etching solution being provided may vary depending on the position of the workpiece. The etching solution ETS provided from the outer sub-nozzle portions SNZ flows along the curved surface or the inclined surface within the groove area HP. Accordingly, the region of the workpiece disposed next (adjacent) to the virtual center line CTL is provided with a larger amount of etching solution ETS and is exposed to the etching solution ETS for a longer time than the outer region thereof. Accordingly, the amount of etching in a region of the workpiece disposed next (adjacent) to the virtual center line CTL becomes greater than the amount of etching in a region of the workpiece disposed in the outer region of the groove area HP, and a recessed area having a smooth curve or slope is defined in the processed surface of the window.

FIG. 11 is a cross-sectional view of an embodiment of a portion of a window manufacturing device according to the inventive concept. FIG. 11 may be a cross-sectional view of a portion of a window manufacturing device, which corresponds to line II-II′ of FIG. 7.

A window manufacturing device PM-2 in an embodiment of the inventive concept may further include guide portions GP1 and GP2 disposed on at least one side of each of the nozzle portions NZP1 and NZP2.

Referring to FIG. 11, in an embodiment of the inventive concept, a first guide portion GP1 may be disposed on one side of the first nozzle portion NZP1, and a second guide portion GP2 may be disposed on one side of the second nozzle portion NZP2. The guide portions GP1 and GP2 may be disposed at predetermined intervals GAP1 and GAP2 from the nozzle portions NZP1 and NZP2 on one side of each of the nozzle portions NZP1 and NZP2. The nozzle portions NZP1 and NZP2 may be controlled to move in a moving direction MVD that follows the shape of the upper surface of the groove area HP, and the adjacently disposed guide portions GP1 and GP2 may also move in a guide moving direction GP-MV according to the moving direction MVD of the groove area HP.

The guide portions GP1 and GP2 may prevent the etching solution ETS provided from the nozzle portions NZP1 and NZP2 from being sprayed to an unintended region. In addition, the guide portions GP1 and GP2 may have a function of adjusting the flow of the etching solution ETS provided from the nozzle portions NZP1 and NZP2 so that the etching solution ETS is uniformly provided onto the workpiece.

One end of each of the guide portions GP1 and GP2 may be disposed next (adjacent) to the upper surface of the groove area HP, and the one end thereof in the direction of the groove area HP may have a brush, fan, or blade shape. The one end of each of the guide portions GP1 and GP2 next (adjacent) to the upper surface of the groove area HP may have a bent angle so as to form a tangential angle with one surface of the workpiece.

In a case in which the window manufacturing device in an embodiment of the inventive concept described with reference to FIGS. 7 to 11 is used, when processing the base glass using an etching solution, a separate pretreatment masking process for distinguishing a portion to which the etching solution is provided from remaining (the other) portions, as well as a separate post-processing process such as surface polishing after etching, may be omitted. In addition, when using the window manufacturing device in an embodiment of the inventive concept, a step difference or discontinuity, which may occur at a boundary between a portion to which the etching solution is provided and a portion to which the etching solution is not provided, does not occur, and therefore, the window manufactured using the window manufacturing device in an embodiment of the inventive concept may exhibit excellent surface quality characteristics without a discontinuity.

When manufacturing window glass using the window glass manufacturing device in an embodiment of the inventive concept, etching may be performed after transforming base glass into a bent or curved state so as to correspond to the shape of the fixing jig using the flexibility of ultra-thin tempered glass used as the base glass, and therefore, the overall thickness of the window glass may be increased, and in the folding portion, the thickness of the window may be easily reduced to a desired shape. Accordingly, the window glass manufactured using the window glass manufacturing device in an embodiment of the inventive concept may exhibit excellent surface quality characteristics and relatively high durability.

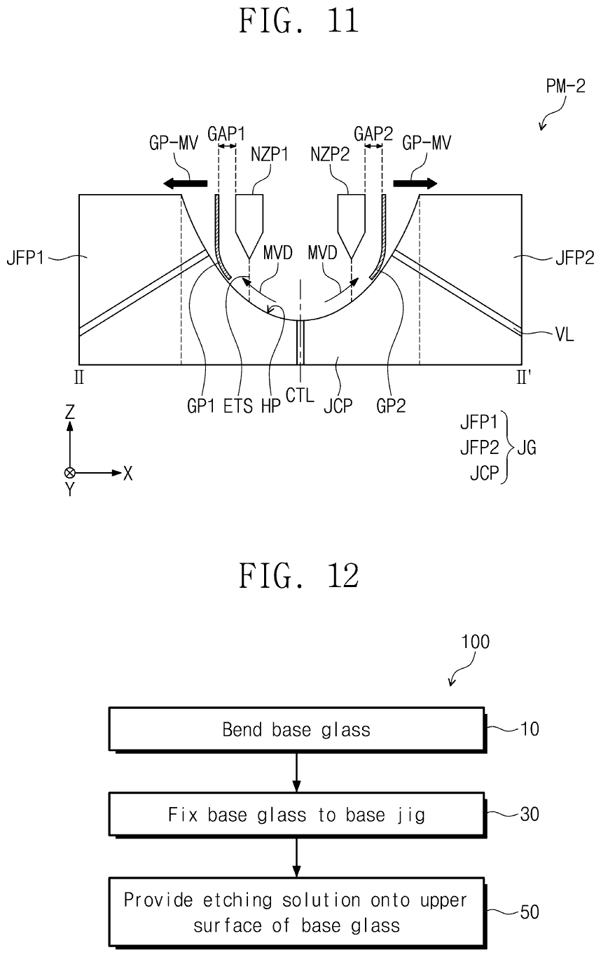

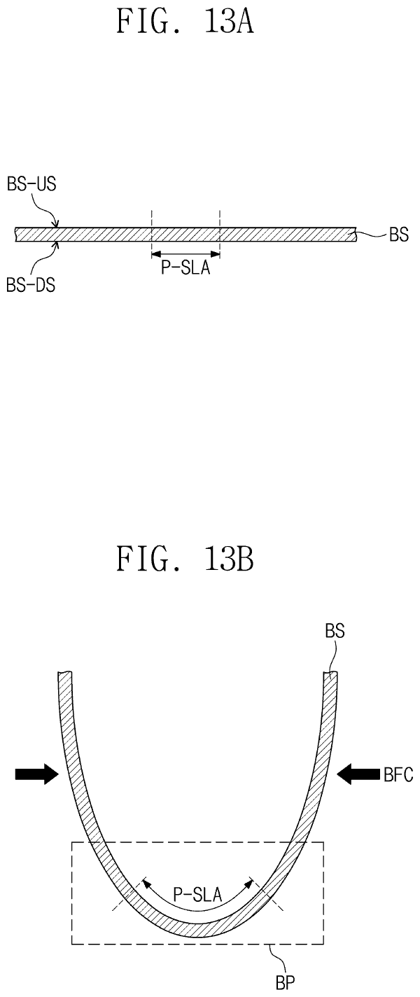

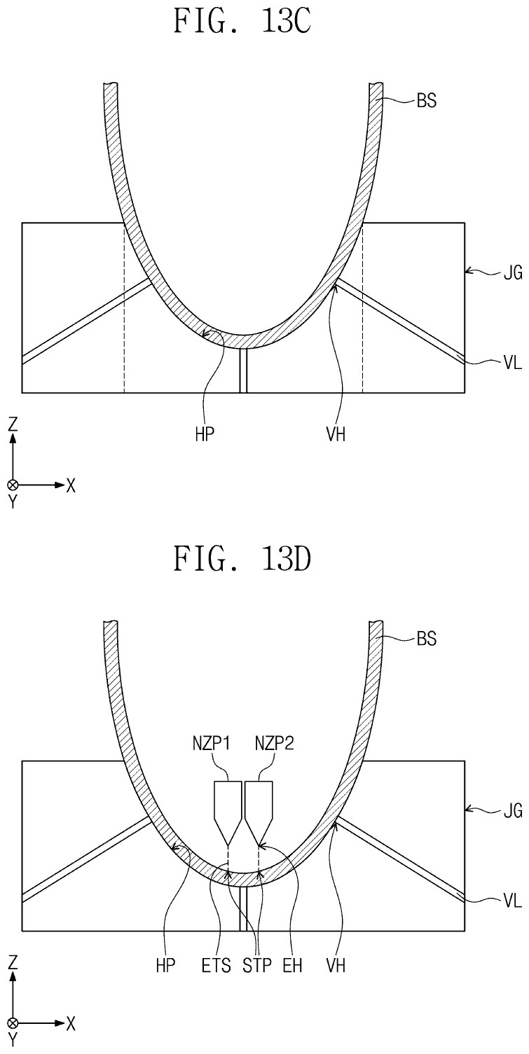

FIG. 12 is a flow chart of an embodiment of a window glass manufacturing method according to the inventive concept. Each of FIGS. 13A to 17B illustrates one operation of the window glass manufacturing method according to the inventive concept. Hereinafter, in the descriptions of the window glass manufacturing method in an embodiment of the inventive concept described with reference to FIGS. 12 to 17B, overlapping contents will not be described again and differences will be mainly described. In addition, the window glass manufacturing method in an embodiment of the inventive concept may be also referred to as a window manufacturing method according to the inventive concept.

The window manufacturing method 100 in an embodiment of the inventive concept may include bending base glass (operation 10), fixing the base glass to a base jig (operation 30), and providing an etching solution onto the upper surface of the base glass (operation 50).

The window manufacturing method 100 in an embodiment of the inventive concept may be a method of manufacturing a window using the window manufacturing device in the embodiment of the inventive concept illustrated in FIGS. 7 to 11. The window manufacturing method 100 in an embodiment of the inventive concept may manufacture a window using the window manufacturing device including a base jig JG including a concavely recessed groove area and nozzle portions NZP1, NZP2, and NZP-a disposed above the base jig in a region corresponding to the groove area and controlled to move.

In the window manufacturing method 100 in an embodiment of the inventive concept, the bending of the base glass 10 may be bending the base glass so as to include a bending portion inserted into the groove area of the window manufacturing device. In addition, the fixing of the base glass to the base jig (operation 30) may be fixing the bent base glass to the base jig so that the bending portion is disposed along the shape of the upper surface of the groove area.

The providing of an etching solution onto the upper surface of the base glass (operation 50) may include providing the etching solution onto the upper surface of the base glass disposed within the groove area using the nozzle portion. The providing of an etching solution onto the upper surface of the base glass (operation 50) may include controlling the degree of etching by the etching solution, depending on the position on the upper surface of the base glass, to form a window having a recessed area defined in the upper surface thereof. In addition, the providing of an etching solution (operation 50) may include controlling the time of exposure to the etching solution or the amount of the etching solution provided, depending on the position on the upper surface of the base glass.

FIG. 13A is a cross-sectional view of an embodiment of a base glass processed using the window manufacturing method according to the inventive concept. The base glass BS is a tempered glass substrate and may have flexibility that allows it to be easily bent.

The base glass BS may include an upper surface BS-US and a lower surface BS-DS facing each other, and each of the upper surface BS-US and the lower surface BS-DS may be a flat surface. The base glass BS may include at least one pre-slimming region P-SLA. The pre-slimming region P-SLA may be processed into the slimming region SLA (refer to FIGS. 6A and 6B) of the window.

FIG. 13B illustrates bending the base glass 10.

The base glass BS may be bent to include a bending portion BP before being provided to the base jig so that it may be easily inserted into the groove area of the base jig. The bending of the base glass 10 may include applying an external force BFC to the base glass BS so that the base glass BS is deformed into a shape including the bending portion BP. The base glass BS may be bent so that the bending portion BP includes the pre-slimming region P-SLA.

FIG. 13C illustrates an embodiment of fixing the base glass to the base jig 30 in the window manufacturing method according to the inventive concept. In the fixing of the base glass to the base jig 30, the bending portion BP of the base glass BS may be disposed in the groove area HP of the base jig JG. The bending portion BP of the base glass BS may be disposed in a deformed shape along the shape of the upper surface of the groove area HP and fixed to the base jig JG.

The base glass BS may be fixed along the shape of the groove area HP using a vacuum state provided through a vacuum suction inlet VH connected to a vacuum line VL and defined in the upper surface of the groove area HP. The fixing of the base glass to the base jig 30 may be fixing the base glass by adsorbing one surface of the base glass BS through the vacuum suction inlet VH defined in the groove area HP.

That is, unlike a typical process in which the base glass BS is disposed on a jig in an unfolded state when the base glass BS is provided for an etching process, the window manufacturing method in an embodiment of the inventive concept may include bending the base glass BS so as to include the pre-slimming region P-SLA and fixing the base glass BS to the base jig JG having a groove area defined therein so as to maintain the bent shape. Accordingly, compared to a typical process in which a separate masking process should be performed as a pretreatment process to distinguish a portion requiring etching from remaining (the other) portions, the window glass manufacturing method in an embodiment of the inventive concept may omit the pretreatment process by fixing the bent base window to the groove area of the base jig defined concavely to reflect the shape of the slimming region desired for the finally manufactured window glass.

FIG. 13D and FIG. 13E illustrate an embodiment of providing an etching solution in the window manufacturing method according to the inventive concept. FIGS. 13D and 13E may illustrate manufacturing a window using a window manufacturing device including a first nozzle portion NZP1 and a second nozzle portion NZP2. One operation of the window manufacturing method in an embodiment of the inventive concept illustrated in FIGS. 13D and 13E may correspond to providing an etching solution using the window manufacturing device in the embodiment of the inventive concept described with reference to FIGS. 9A and 9B.

In an embodiment of the inventive concept, the providing of an etching solution (operation 50) may include continuously providing the etching solution ETS onto the upper surface of the base glass BS while moving each of the first nozzle portion NZP1 and the second nozzle portion NZP2 from the center of the groove area HP toward the outer direction.

Each of The first nozzle portion NZP1 and the second nozzle portion NZP2 may move along a moving direction MVD that follows the shape of the upper surface of the base glass BS disposed on the groove area HP within a region corresponding to the groove area HP. Each of the first nozzle portion NZP1 and the second nozzle portion NZP2 may move while maintaining a predetermined distance from the upper surface of the base glass BS. The discharge outlets EH of the first nozzle portion NZP1 and the second nozzle portion NZP2 through which the etching solution ETS is discharged and the upper surface of the base glass BS may be spaced apart from each other by a predetermined distance in direction corresponding to the Z-axis Z. In an embodiment, a separation distance GSP between the nozzle portions NZP1 and NZP2 and the upper surface of the base glass BS at a position corresponding to a start point STP and a separation distance GEP between the nozzle portions NZP1 and NZP2 and the upper surface of the base glass BS at a position corresponding to an end point may be substantially the same as each other, for example. The nozzle portions NZP1 and NZP2 may be moved so that the separation distance between the discharge outlets EH of the first nozzle portion NZP1 and the second nozzle portion NZP2, through which the etching solution ETS is discharged, and the upper surface of the base glass BS in direction corresponding to the Z-axis Z is uniformly maintained.

Each of the first nozzle portion NZP1 and the second nozzle portion NZP2 may continuously provide the etching solution ETS onto the base glass BS by starting the provision of the etching solution ETS at a position corresponding to the start point STP, which is the point of the initial state NZP1-I or NZP2-I, and progressing toward a point corresponding to the edge portion EDP of the slimming region corresponding to the point of the end state NZP1-F or NZP2-F.

The etching solution ETS provided by each of the first nozzle portion NZP1 and the second nozzle portion NZP2 while moving from the initial state NZP1-I or NZP2-I to the end state NZP1-F or NZP2-F flows along the curved surface or the inclined surface within the groove area HP. A flow direction EMV of the etching solution ETS may be a direction from the edge portion EDP to the start point STP. Accordingly, the amount of etching in a portion that is bent and fixed to be disposed at the center of the groove area HP may be greater than the amount of etching in remaining (the other) portions of the base glass BS.

In a window manufactured in one operation of the window manufacturing method in an embodiment of the inventive concept illustrated in FIGS. 13C and 13D, a concavely recessed area CCP may be defined in the slimming region SLA as illustrated in FIG. 6A or the like, and an exposed surface of the recessed area CCP may have a curved shape without a discontinuity.

When the base jig JG-a in the embodiment of the inventive concept illustrated in FIG. 8B is used in one operation of the window manufacturing method in an embodiment of the inventive concept illustrated in FIGS. 13C and 13D, the window manufactured in the one operation of the window manufacturing method in an embodiment of the inventive concept may have a concavely recessed area CCP-a defined in the slimming region SLA as illustrated in FIG. 6B, and an exposed surface of the recessed area CCP-a may include a flat surface and inclined surfaces without a discontinuity and have a smooth slope shape in the boundary portion.

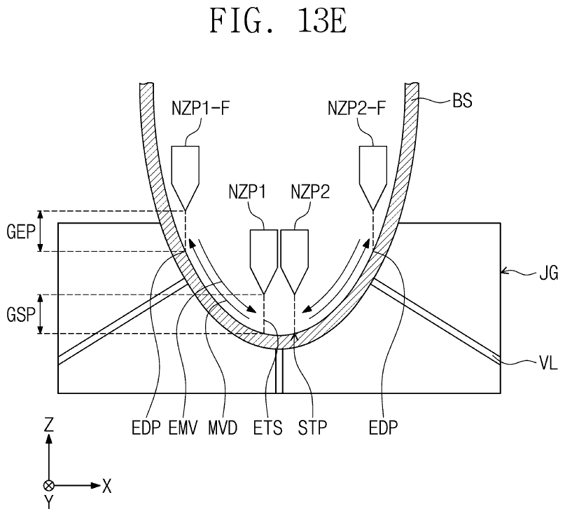

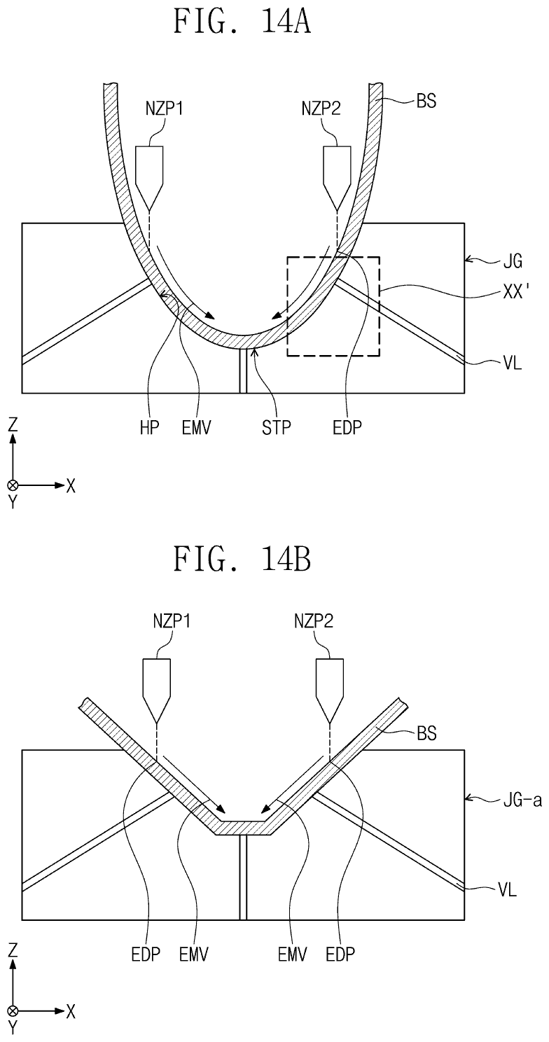

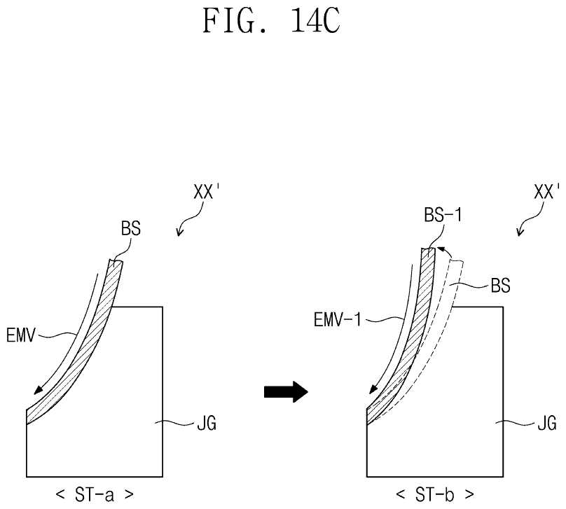

Each of FIGS. 14A and 14B illustrates an embodiment of an embodiment of an operation of providing an etching solution in the window manufacturing method according to the inventive concept. FIG. 14A illustrates an etching operation using the window manufacturing device including the base jig JG illustrated in FIG. 8A, and FIG. 14B illustrates an etching operation using the window manufacturing device including the base jig JG-a illustrated in FIG. 8B.

Referring to FIGS. 14A and 14B, each of the first nozzle portion NZP1 and the second nozzle portion NZP2 may be controlled to be fixed at one point.

In the window manufacturing method in an embodiment of the inventive concept, the nozzle portions NZP1 and NZP2 may be disposed so as to be offset to at least one side within the region of the groove area HP. The points at which the nozzle portions NZP1 and NZP2 are fixed and disposed may be portions corresponding to the edge portions EDP of the slimming region. The width of the slimming region SLA (refer to FIGS. 6A and 6B) may be adjusted by adjusting the fixed positions of the nozzle portions NZP1 and NZP2.

The etching solution ETS sprayed through the nozzle portions NZP1 and NZP2 may etch the base glass BS by flowing along the upper surface of the base glass BS. The flow direction EMV and flow speed of the etching solution ETS may be adjusted by the degree of bending or inclination angle of the curved surface of the base glass BS fixed to the groove area HP. By adjusting the flow of the etching solution ETS, the degree of etching of the base glass BS may be adjusted, and accordingly, a smooth curved or inclined surface without a step difference may be formed on one side of the window.

FIG. 14C compares the flow state of the etching solution by enlarging region XX′ of FIG. 14A. FIG. 14C illustrates a case in which a first state ST-a and a second state ST-b differ in the degrees of inclination of the base glasses BS and BS-1 placed on the base jig JG. The degree of inclination of the base glass BS-1 in the second state ST-b may be greater than that of the base glass BS in the first state ST-a, and in this case, the flow speed of the etching solution in a flow direction EMV-1 in the second state ST-b may be greater than that of the etching solution in the flow direction EMV in the first state ST-a. In this case, a relatively large amount of etching solution ETS may be provided more quickly to the upper surface of the base glass BS disposed in the central portion of the base jig JG, and the upper surface of the base glass BS disposed relatively next (adjacent) to the outer edge of the groove area HP may be exposed to the etching solution ETS for a shorter time. Accordingly, the recessed area CCP (refer to FIG. 6A) of the manufactured window may have a curved shape with a greater tangential slope in a portion next (adjacent) to the edge portion EDP. FIG. 14C illustrates a method for controlling the flow speed of the etching solution ETS, but the inventive concept is not limited thereto, and the supply amount and supply speed of the etching solution ETS may be controlled by a method such as controlling the operation of the etching solution supply units ESP1 and ESP2 (refer to FIG. 7) or changing the shape of the base jig JG.

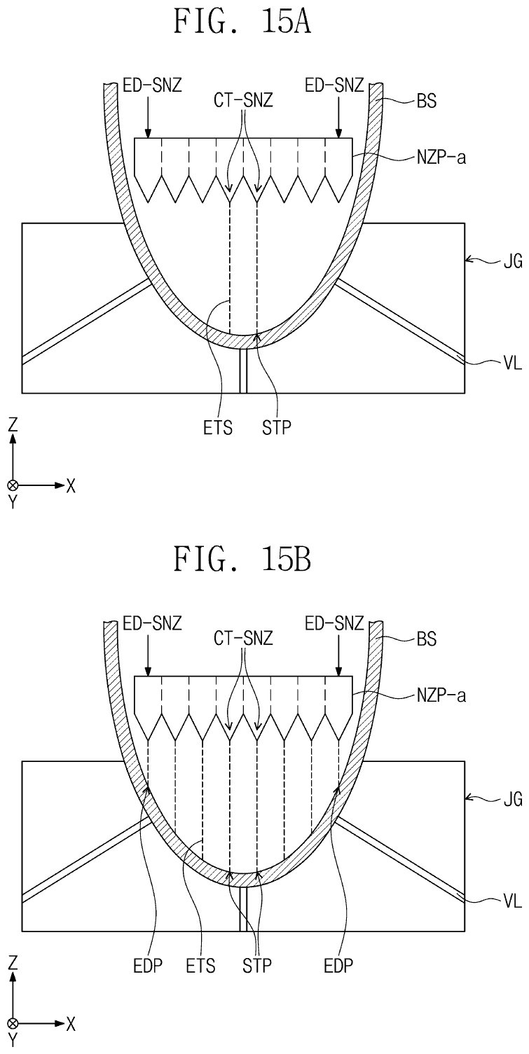

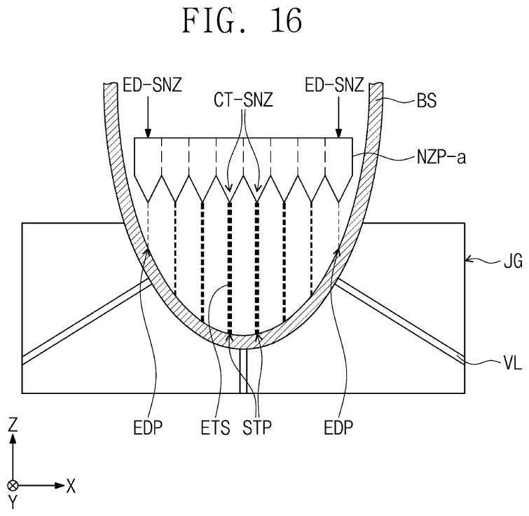

Each of FIGS. 15A to 16 illustrates an embodiment of an operation of providing an etching solution in the window manufacturing method according to the inventive concept. Each of FIGS. 15A to 16 may illustrate an operation of manufacturing a window using the window manufacturing device in which the nozzle portion NZP-a includes a plurality of sub-nozzle portions CT-SNZ and ED-SNZ. One operation of the window manufacturing method in an embodiment of the inventive concept illustrated in FIGS. 15A to 16 may correspond to providing an etching solution using the window manufacturing device in the embodiment of the inventive concept described with reference to FIG. 10A.

In the window manufacturing method in an embodiment of the inventive concept, the nozzle portion NZP-a may be disposed to correspond to the groove area HP. The nozzle portion NZP-a may include a plurality of sub-nozzle portions CT-SNZ and ED-SNZ arranged in the direction corresponding to the X-axis X, i.e., in the direction which is the first direction. The nozzle portion NZP-a may include central sub-nozzle portions CT-SNZ disposed in the central portion and outer sub-nozzle portions ED-SNZ disposed in the outer portions.

Referring to FIGS. 15A and 15B, the providing of the etching solution may include sequentially controlling the sub-nozzle portions CT-SNZ and ED-SNZ to open, starting from the center of the groove area HP defined in the base jig JG and progressing toward the outer portion to provide the etching solution ETS.

The amount of the etching solution ETS sprayed from each of the sub-nozzle portions CT-SNZ and ED-SNZ may be adjusted according to the shape of the desired window. According to the shape of the groove area CCP of the slimming region of the desired window, the spray position, pressure, and time of the etching solution provided from the sub-nozzle portions CT-SNZ and ED-SNZ may be adjusted. In an embodiment, the degree of spraying of the etching solution ETS through the sub-nozzle portions CT-SNZ and ED-SNZ may be adjusted so that the amount of etching is the greatest in the central portion of the base glass BS and decreases toward the outer edges, for example.

The providing of the etching solution (operation 50) using the nozzle portion NZP-a including the sub-nozzle portions CT-SNZ and ED-SNZ may be sequentially performed from the state illustrated in FIG. 15A to the state illustrated in FIG. 15B. FIG. 15A illustrates providing the etching solution ETS onto the base glass BS from the central sub-nozzle portions CT-SNZ disposed in the central portion among the sub-nozzle portions included in the nozzle portion NZP-a. FIG. 15B illustrates providing the etching solution ETS onto the base glass BS from all of the central sub-nozzle portions CT-SNZ and the outer sub-nozzle portions ED-SNZ.

In an embodiment of the inventive concept, in order to make the amount of etching the greatest in the central portion of the base glass BS and make it decrease toward the outer edges, as illustrated in FIGS. 15A and 15B, the etching solution ETS is first sprayed from the central sub-nozzle portions CT-SNZ, and then, over time, the sub-nozzle portions are sequentially controlled to be in an open state toward the direction of the outer sub-nozzle portions ED-SNZ, thereby expanding a region to which the etching solution ETS is provided.

In the window manufacturing method in an embodiment of the inventive concept, the points at which the central sub-nozzle portions CT-SNZ are disposed may correspond to the start points STP to which the etching solution ETS is first supplied. In addition, the points at which the outer sub-nozzle portions ED-SNZ are disposed may correspond to the edge portions EDP of the slimming region SLA.

In the window manufacturing method in an embodiment of the inventive concept, in order to sequentially supply the etching solution from the center to the outer edges, the sub-nozzle portions may be sequentially controlled to be in an open state in the order from the central sub-nozzle portions CT-SNZ to the outer sub-nozzle portions ED-SNZ. The etching solution ETS provided from the outer sub-nozzle portions ED-SNZ flows along the upper surface of the base glass BS, so that the etching solution ETS is concentrated on the central portion.

Accordingly, the central portion of the base glass BS fixed to the groove area HP may be etched in the most concave shape, and the entirety of the portion to which the etching solution ETS is provided may be etched to have a smooth surface without a discontinuity.

FIG. 16 illustrates etching the base glass by controlling the amount of etching solution ETS provided from each of the sub-nozzle portions CT-SNZ and ED-SNZ. In the window manufacturing method in an embodiment of the inventive concept, the providing of the etching solution (operation 50) may include controlling the sub-nozzle portions CT-SNZ and ED-SNZ so that the amount of etching solution ETS provided from the central sub-nozzle portions CT-SNZ disposed in the central portion of the groove area is greater than the amount of etching solution ETS provided from the outer sub-nozzle portions ED-SNZ disposed in the outer edges of the groove area.

Since a relatively larger amount of etching solution ETS is sprayed from the central sub-nozzle portions CT-SNZ than from the outer sub-nozzle portions ED-SNZ, and the etching solution ETS provided from the outer sub-nozzle portions ED-SNZ flows along the upper surface of the base glass BS, the etching solution ETS is concentrated on the central portion of the base glass BS fixed to the groove area HP.

Accordingly, the central portion of the base glass BS fixed to the groove area HP may be etched in the most concave shape, and the entirety of the portion to which etching solution ETS is provided may be etched to have a smooth surface without a discontinuity. That is, the window manufactured in one operation of the window manufacturing method in an embodiment of the inventive concept illustrated in FIGS. 15A to 16 has a concavely recessed area CCP defined in the slimming region SLA as illustrated in FIG. 6A or the like, and the exposed surface of the recessed area CCP may have a curved shape without a discontinuity.

In one operation of the window manufacturing method in an embodiment of the inventive concept illustrated in FIGS. 15A to 16, when the base jig JG-a in an embodiment of the inventive concept illustrated in FIG. 8B is used, the window manufactured in one operation of the window manufacturing method in an embodiment of the inventive concept has a concavely recessed area CCP-a defined in the slimming region SLA as illustrated in FIG. 6B, and the exposed surface of the recessed area CCP-a may include a flat surface and inclined surfaces without a discontinuity and have a smooth slope shape in the boundary portion.

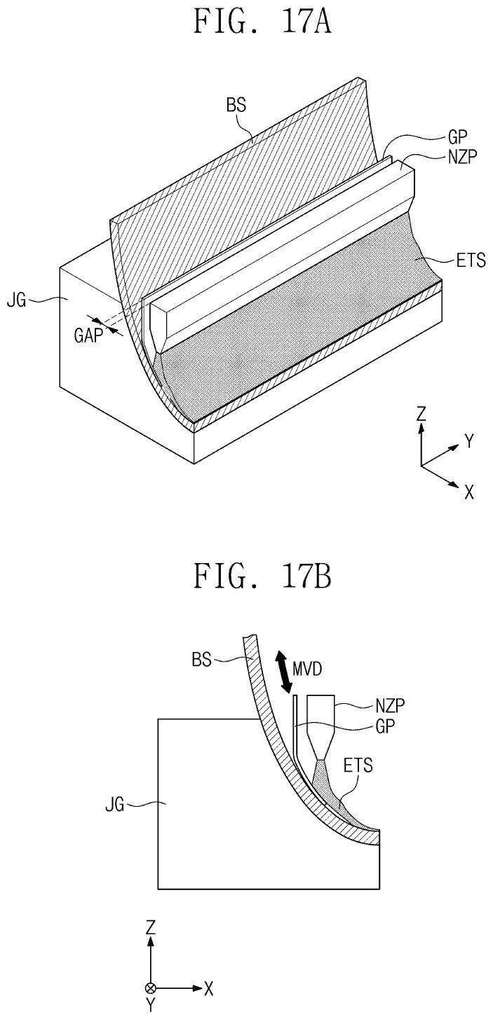

FIGS. 17A and 17B illustrate an embodiment of an operation of providing an etching solution in the window manufacturing method according to the inventive concept. FIG. 17A is a perspective view partially illustrating only a portion of the window manufacturing device and a form of providing the etching solution in the providing of the etching solution, and FIG. 17B corresponds to a cross-sectional view partially illustrating only a portion of the window manufacturing device and a form of providing the etching solution in the providing of the etching solution.

FIGS. 17A and 17B illustrate an etching operation using the window manufacturing device including the base jig JG illustrated in FIG. 8A, and although not illustrated, the providing of the etching solution described with reference to FIGS. 17A and 17B may be equally applied to a case in which the window manufacturing device including the base jig JG-a, which is illustrated in FIG. 8B, is used.

In an embodiment of the inventive concept, a guide portion GP may be disposed on one side of the nozzle portion NZP and be spaced apart from the nozzle portion NZP by a predetermined distance GAP. The nozzle portion NZP and the guide portion GP may be controlled to move in a moving direction MVD that follows the shape of the upper surface of the groove area HP. The nozzle portion NZP and the guide portion GP may be simultaneously moved in the moving direction MVD while maintaining a predetermined distance GAP.

The guide portion GP may be moved in a state in which one end thereof contacts the upper surface of the base glass BS. In addition, the etching solution ETS discharged from the nozzle portion NZP may be preferentially provided onto the guide portion GP and uniformly provided onto the base glass BS along the curved or inclined surface of one end of the guide portion GP.

When the providing of the etching solution (operation 50) is performed in a state in which the guide portion GP is disposed on one side of the nozzle portion NZP, the etching solution ETS may be prevented from spreading or splashing to an unintended region, and the etching solution ETS may be uniformly supplied onto the entirety of the surface of the base glass BS, thus improving etching quality. Accordingly, the quality of the upper surface of the window manufactured by the window manufacturing method in an embodiment of the inventive concept may be improved.

In the descriptions of the window glass manufacturing device in an embodiment of the inventive concept and the window glass manufacturing method in an embodiment of the inventive concept, which are described with reference to FIGS. 7 to 17B, the method of manufacturing the window glass corresponding to the form of the electronic device illustrated in FIG. 1A or the like is mainly described, but the inventive concept is not limited thereto, and the manufacturing device in an embodiment of the inventive concept and the manufacturing method in an embodiment of the inventive concept may also be used for manufacturing not only window glass including a plurality of folding portions, but also window glass having variously shaped folding portions.

In the case of the window glass manufacturing method in an embodiment of the inventive concept, when processing base glass using an etching solution, a separate pretreatment masking process for distinguishing a portion to which the etching solution is provided from remaining (the other) portions, as well as a separate post-processing process such as surface polishing after etching, may be omitted. Accordingly, processability may be improved by the window glass manufacturing method according to the inventive concept. In addition, when using the window glass manufacturing method in an embodiment of the inventive concept, a step difference or discontinuity that may occur at the boundary between a portion to which the etching solution is provided and a portion to which the etching solution is not provided may not occur, and therefore, the surface of the manufactured window glass may exhibit excellent quality characteristics without a discontinuity. Accordingly, the electronic device including the window glass manufactured by the window glass manufacturing device in an embodiment of the inventive concept or the window glass manufacturing method in an embodiment of the inventive concept may exhibit excellent display quality since issues such as image distortion or visible blemishes that may occur at discontinuities are resolved.

In addition, when manufacturing the window glass using the window glass manufacturing method in an embodiment of the inventive concept, base glass is bent or curved by utilizing the flexibility of ultra-thin tempered glass used as the base glass, and the base glass in a bent form is fixed to the groove area of the base jig, and then etching is performed, and in this way, the thickness of a portion for which etching is not desired may be maintained as a sufficient thickness. Therefore, when manufacturing the window using the window glass manufacturing method in an embodiment of the inventive concept, the overall thickness of the window corresponding to the non-folding portion may be increased, and in a portion corresponding to the folding portion, the thickness of the window glass may be easily reduced to a desired shape. Accordingly, the window glass manufactured by the window glass manufacturing method in an embodiment of the inventive concept may exhibit excellent surface quality characteristics and relatively high durability.

The window glass manufacturing device in an embodiment of the inventive concept may be used to manufacture the window glass with excellent surface quality by easily controlling the position of the nozzle portion or the amount of etching solution provided from the nozzle portion according to the shape of the recessed area of the slimming region desired for the window.

The window glass manufacturing method in an embodiment of the inventive concept may provide the window glass having a desired recessed shape and excellent surface quality without a discontinuity on the surface of the recessed area by controlling the provided amount of etching solution or the speed of providing the etching solution in a process operation.

In addition, the window glass manufacturing device and the window glass manufacturing method in an embodiment of the inventive concept may improve processability by omitting a pretreatment process and a postprocessing process before and after the etching process for slimming.

Although the above has been described with reference to preferred embodiments of the inventive concept, those skilled in the art or those of ordinary skill in the art will understand that various modifications and changes may be made to the inventive concept within the scope that does not depart from the spirit and technical field of the inventive concept described in the claims to be described later.

Accordingly, the technical scope of the inventive concept should not be limited to the content described in the detailed description of the specification, but should be determined by the claims described hereinafter.

What is claimed is:

1. A window glass manufacturing device comprising:
a base jig comprising flat surfaces spaced apart from each other in a first direction and a groove area concavely recessed with respect to the flat surfaces and extending in a second direction; and
a nozzle portion disposed above the base jig so as to correspond to the groove area and controlled to move in at least one of a first moving direction or a second moving direction which is parallel to the first direction and perpendicular to the first moving direction.

2. The window glass manufacturing device of claim 1, wherein an upper surface of the groove area comprises a curved surface without a discontinuity or an inclined surface without a discontinuity.

3. The window glass manufacturing device of claim 1, wherein the nozzle portion moves along a shape of an upper surface of the groove area within a region corresponding to the groove area.

4. The window glass manufacturing device of claim 2, wherein an inclination angle of the inclined surface is between 10 or more degrees and 45 or less degrees.

5. The window glass manufacturing device of claim 1, wherein the nozzle portion comprises a first nozzle portion and a second nozzle portion spaced apart from each other in the first direction with respect to a center of the base jig.

6. The window glass manufacturing device of claim 5, wherein the first nozzle portion and the second nozzle portion follow a shape of an upper surface of the groove area and are controlled to move in opposite directions with respect to the center.

7. The window glass manufacturing device of claim 6, wherein each of the first nozzle portion and the second nozzle portion is controlled to move while maintaining a predetermined distance from the upper surface of the groove area.

8. The window glass manufacturing device of claim 1, wherein the nozzle portion comprises a plurality of sub-nozzle portions arranged in the first direction, wherein open and closed states of the sub-nozzle portions or discharge amounts discharged from the sub-nozzle portions are independently controlled.

9. The window glass manufacturing device of claim 1, wherein vacuum suction inlets are defined in the groove area of the base jig.

10. The window glass manufacturing device of claim 1, wherein the base jig comprises a plurality of sub-jigs separated from each other,
wherein a shape of the groove area is adjusted by a combination of the plurality of sub-jigs.

11. A window glass manufacturing method using a window glass manufacturing device comprising a base jig comprising a groove area concavely recessed and a nozzle portion disposed above the base jig and controlled to move in a region corresponding to the groove area, the method comprising:
bending a base glass so as to include a bending portion inserted into the groove area;
fixing the base glass to the base jig so that the bending portion is disposed along a shape of an upper surface of the groove area; and
providing an etching solution onto an upper surface of the base glass disposed in the groove area using the nozzle portion.

12. The window glass manufacturing method of claim 11, wherein the providing the etching solution comprises controlling a degree of etching by the etching solution according to a position on the upper surface of the base glass to form a window having a recessed area defined therein and comprising a curved surface without a discontinuity or an inclined surface without a discontinuity on the upper surface of the base glass.

13. The window glass manufacturing method of claim 11, wherein the providing the etching solution comprises controlling at least one of an exposure time to the etching solution or an amount of the etching solution provided, depending on a position on the upper surface of the base glass.

14. The window glass manufacturing method of claim 11, wherein the fixing the base glass to the base jig is fixing one surface of the base glass by suction through a vacuum suction inlet defined in the groove area.

15. The window glass manufacturing method of claim 11, wherein:
the nozzle portion comprises a first nozzle portion and a second nozzle portion spaced apart from each other in a first direction; and
the providing the etching solution comprises continuously providing the etching solution onto the upper surface of the base glass while moving each of the first nozzle portion and the second nozzle portion from a center of the groove area toward an outer direction.

16. The window glass manufacturing method of claim 15, wherein each of the first nozzle portion and the second nozzle portion is controlled to move so as to follow the shape of the upper surface of the groove area while maintaining a predetermined distance from the upper surface of the base glass.

17. The window glass manufacturing method of claim 11, wherein:
the nozzle portion comprises a first nozzle portion and a second nozzle portion fixedly spaced apart from each other in opposite directions at a predetermined distance with respect to a center of the base jig; and
in the providing the etching solution, the etching solution discharged from each of the first nozzle portion and the second nozzle portion is provided to flow along the upper surface of the base glass in a direction of the center at a portion corresponding to a position of each of the first nozzle portion and the second nozzle portion.

18. The window glass manufacturing method of claim 11, wherein:
the nozzle portion comprises a plurality of sub-nozzle portions arranged in a first direction so as to correspond to the groove area; and
the providing the etching solution is providing the etching solution by sequentially controlling the sub-nozzle portions to open, starting from a center of the groove area and progressing toward an outer portion of the groove area.

19. The window glass manufacturing method of claim 11, wherein:
the nozzle portion comprises a plurality of sub-nozzle portions arranged in a first direction so as to correspond to the groove area; and
the providing the etching solution comprises controlling the sub-nozzle portions so that an amount of the etching solution provided from the sub-nozzle portions disposed in a central portion of the groove area is greater than an amount of the etching solution provided from the sub-nozzle portions disposed in outer portions of the groove area.

20. The window glass manufacturing method of claim 11, wherein:
the window glass manufacturing device further comprises a guide portion disposed to be spaced apart from one side of the nozzle portion above the base jig; and
the providing the etching solution comprises controlling a movement of the guide portion and the nozzle portion to follow the shape of the upper surface of the groove area while maintaining a predetermined separation distance therebetween.
